(19) United States
(12) Patent Application Publication
(10) Pub. No.: US 2010/0085495 A1
(43) Pub. Date: Apr. 8, 2010

(54) OPTICAL HEAD DEVICE AND OPTICAL INFORMATION RECORDING/REPRODUCING DEVICE

(76) Inventor: Ryuichi Katayama, Tokyo (JP)

Correspondence Address: Mr. Jackson Chen, 6535 N. STATE HWY 161, IRVING, TX, 75039, US

(21) Appl. No.: 12/593,511

(22) PCT Filed: Mar. 5, 2008
(86) PCT No.: PCT/JP2008/053986

§ 371 Date: Dec. 7, 2009

(30) Foreign Application Priority Data
Mar. 28, 2007 (JP) 2007-085347

(51) Int. Cl. G02F 1/13

(52) U.S. Cl. 349/2

(57) ABSTRACT

In front of the objective lens of an optical head deice, a birefringence correction element (5a) having a first birefringence correcting section consisting of a liquid crystal polymer layer (15a) and electrodes (14a, 14b), a second birefringence correcting section consisting of a liquid crystal polymer layer (15b) and electrodes (14c, 14d), and a third birefringence correcting section consisting of a liquid crystal polymer layer (15c) and electrodes (14e, 14f) is provided. The first birefringence correcting section corrects the impact of vertical birefringence of the protective layer in an optical recording medium variable depending on the kind of an optical recording medium, and the second and third birefringence correcting sections correct the impact of the recording medium protective layer in-plane birefringence that varies by the kind of the optical recording medium.

### TECHNICAL FIELD

The present invention relates to an optical head device and an optical information recording/reproducing device for carrying out recording and reproducing on plural types of optical recording media each having different optical condition for use or different optical characteristics of the recording mark. The present application claims the benefit of the priority based on Japanese Patent Application No. 2007-85347 and the disclosures of Japanese Patent Application No. 2007-85347 are hereby incorporated by reference into the present application.

### BACKGROUND ART

As an optical system of an optical head device for carrying out recording and reproducing on an optical recording medium, the optical system called the polarization optical system is generally used. The optical head device includes a light separation part for separating light emitted from a light source from light reflected from an optical recording medium. In the polarization optical system, light incident on the light separation part from the side of the light source and light incident on the light separation part from the side of an objective lens side are linearly-polarized lights whose polarization directions are perpendicular to each other. The light separation part has a characteristic that emits the linearly-polarized light incident from the side of the light source to the side of the objective lens with high efficiency and emits the linearly-polarized light incident from the side of the objective lens to the side of an optical detector with high efficiency. Accordingly, since the amount of light emitted from the objective lens is large in recording information to the optical recording medium, a high output of light can be obtained, and since the amount of light received by the optical detector is large in reproducing information from the optical recording medium, a high signal-to-noise ratio can be obtained.

Meanwhile, the optical recording medium has a protection layer, and the polycarbonate whose cost is low is usually employed as the protection layer. However, the polycarbonate has the birefringence property. In the case where the birefringence exists in the protection layer of the optical recording medium, the light incident on the light separation part from the side of the objective lens generally becomes ellipsoidal polarized light, and thus the efficiency of the case where the light incident on the light separation part from the side of the objective lens is emitted from the light separation part to the side of the optical detector decreases. Accordingly, the amount of light received by an optical detector decreases in reproducing information from the optical recording medium, resulting in decrease of the obtained signal-to-noise ratio. In a case where recording and reproducing is carried out to plural types of optical recording media each having different optical condition for use, the birefringence property of the protection layer of the optical recording medium varies depending on the type of the optical recording medium. Accordingly, in order to obtain a high signal-to-noise ratio, it is required to correct the influence of the birefringence of the protection layer of the optical recording medium, the birefringence varying depending on the type of the optical recording medium.

Japanese Laid-Open Patent Application JP-P2006-196156A discloses an optical head device that corrects the influence of the birefringence of the protection layer of an optical recording medium, the birefringence varying depending on the type of the optical recording medium. FIG. 1 shows major parts of the optical head device. Emission light from a semiconductor laser 31 served as a light source is incident on a polarization beam splitter 32 as the P-polarization and almost 100% of the incident light transmits through the splitter, is converted from a divergent light into a parallel light by a collimator lens 33, is converted from a linearly-polarized light into a circularly-polarized light by a ¼ wavelength plate 34, transmits through a birefringence correction element 35, is converted from a parallel light into a convergent light by an objective lens 36, and is focused on a disk 37 which serves as an optical recording medium. The reflection light from the disk 37 is converted from a divergent light into a parallel light by the objective lens 36, transmits through the birefringence correction element 35, is converted from a circularly-polarized light to a linearly-polarized light whose polarization direction is orthogonal to that of the linearly-polarized light in an outward path by the ¼ wavelength plate 34, is converted from a parallel light into a convergent light by the collimator lens 33, is incident on the polarization beam splitter 32 as an S-polarization and almost 100% of the incident light is reflected, is given the astigmatism by an astigmatism lens 38, and is received by an optical detector 39.

FIG. 2 is a cross sectional view of the birefringence correction element 35. The birefringence correction element 35 is configured by sandwiching a liquid crystal polymer layer 42 between a substrate 40a and a substrate 40b. An electrode 41a and an electrode 41b for applying a voltage to the liquid crystal polymer layer 42 are formed on the surface of the substrate 40a facing to the liquid crystal polymer layer 42 and the surface of the substrate 40b facing to the liquid crystal polymer layer 42. The electrode 41a is a pattern electrode, and the electrode 41b is a whole surface electrode.

FIGS. 3A and 4A are plane views of the electrode 41a in the birefringence correction element 35. FIGS. 3B and 4B are cross sectional views of the liquid crystal polymer layer 42 in the birefringence correction element 35. As shown in FIGS. 3A and 4A, the electrode 41a is divided into four regions, a region 43a to a region 43d, by three concentric circles whose center is the optical axis. In this manner, values of the voltages applied to the liquid crystal polymer layer 42 can be independently set to the regions 43a to 43d. The dashed lines in the drawings show circles having the diameter equivalent to the effective diameter of the objective lens 36. The arrowed lines in the drawings show the longitudinal directions of the liquid crystal polymers in the liquid crystal polymer layer 42. The liquid crystal polymer layer 42 has a uniaxial refractive index anisotropy where the direction of the optical axis is the longitudinal direction of the liquid crystal polymer.

In a case where the protection layer of the disk 37 does not have the birefringence property, the voltage is not applied between the electrode 41a and the electrode 41b. On this occasion, as shown in FIGS. 3A and 3B, the longitudinal directions of the liquid crystal polymers in the liquid crystal polymer layer 42 are parallel to the optical axis of an incident light in each of the region 43a to the region 43d. Accordingly, when a light transmits through the birefringence correction element 35, the polarization state of the light does not chance. Meanwhile, when the protection layer of the disk 37 has a predetermined birefringence property, predetermined voltages are applied between the region 43a to the region 43d of the electrode 41a and the electrode 41b, respectively. On this occasion, as shown in FIGS. 4A and 4B, the longitudinal directions of the liquid crystal polymers of the liquid crystal polymer layer 42 make a predetermined angle with the optical axis of the incident light in a surface including the optical axis of the incident light. The angle becomes larger from the region 43a toward the region 43d. Thus, when a light transmits through the birefringence correction element 35, a predetermined change of the polarization state occurs. As a result, a change of the polarization state occurring because of the birefringence of the protection layer. of the disk 37 when a light transmits through the protection layer of the disk 37 is cancelled by the change of the polarization state occurring when the light transmits through the birefringence correction element 35, and the influence of the birefringence of the protection layer of the disk 37 is corrected.

The protection layer of the optical recording medium usually has the biaxial refractive index anisotropy. By referring the three major axes as an X-axis, a Y-axis, and a Z-axis, the XYZ coordinates can be determined so that the X-axis and the Y-axis can be perpendicular to the normal line direction of the optical recording medium and the Z-axis can be parallel to the normal line direction of the optical recording medium. When the three major reflective indexes corresponding to the three major axes are nx, ny, and nz, the in-plane birefringence can be defined as Δni=nx−ny and the vertical birefringence can be defined as Δnv=(nx+ny)/2−nz.

FIG. 5 shows a calculation example of the relationship between the in-plane birefringence of the protection layer of the optical recording medium and the amount of light received by the optical detector in a case where the wavelength of the light source is 405 nm, the numerical aperture of the objective lens is 0.85, and the thickness of the protection layer of the optical recording medium is 0.1 mm. The vertical axis in the drawing represents the relative amount of received light; the relative amount of received light is normalized by the amount of the received light in a case where the in-plane birefringence is 0. In this case, it is found that the relative amount of received light decreases as the absolute value of the in-plane birefringence increases but the degree of the reduction is very small.

FIG. 6 shows a calculation example of the relationship between the vertical birefringence of a protection layer of the optical recording medium and the amount of light received by the optical detector in the case where the wavelength of the light source is 405 nm, the numerical aperture of the objective lens is 0.85, and the thickness of the protection layer of the optical recording medium is 0.1 mm. The vertical axis in the drawing represents the relative amount of received light; the relative amount of received light is normalized by the amount of the received light in a case where the vertical birefringence is 0. In this case, it is found that the relative amount of received light decreases as the absolute value of the vertical birefringence increases but the degree of the reduction is very small.

FIG. 7 shows a calculation example of the relationship between the in-plane birefringence of a protection layer of an optical recording medium and the amount of light received by the optical detector in a case where the wavelength of the light source is 405 nm, the numerical aperture of the objective lens is 0.65, and the thickness of the protection layer of the optical recording medium is 0.6 mm. The vertical axis in the drawing represents the relative amount of received light; the relative amount of received light is normalized by the amount of received light in the case where the in-plane birefringence is 0. In this case, it is found that the relative amount of received light decreases as the absolute value of the in-plane birefringence increases and the relative amount of the received light in a case where the absolute value of the in-plane birefringence is 1×10⁻⁴ is 0.4 or less.

FIG. 8 shows a calculation example of the relationship between the vertical birefringence of a protection layer of an optical recording medium and the amount of light received by the optical detector in the case where the wavelength of the light source is 405 nm, the numerical aperture of the objective lens is 0.65, and the thickness of the protection layer of the optical recording medium is 0.6 mm. The vertical axis in the drawing represents the relative amount of received light; the relative amount of received light is normalized by the amount of received light in the case where the vertical birefringence is 0. In this case, it is found that the relative amount of received light decreases as the vertical birefringence increases and the relative amount of received light in the case where the absolute value of the vertical birefringence is 1×10⁻³ is 0.6 or less.

In a case where the polycarbonate is used for a protection layer of an optical recording medium, the in-plane birefringence depends on a condition in manufacturing the protection layer and the absolute value becomes approximately 1×10⁻⁴ at the maximum. Meanwhile, the vertical birefringence is almost uniquely determined depending on the material of the protection layer and is approximately 7×10⁻⁴. Accordingly, in the case of using an optical recording medium corresponding to the optical condition where the wavelength of the light source is 405 nm, the numerical aperture of the objective lens is 0.85, and the thickness of the protection layer of the optical recording medium is 0.1 mm, since both of the in-plane birefringence and the vertical birefringence scarcely deteriorate the amount of light received by the optical detector, it is not required to correct the influences of them. However, in the case of using an optical recording medium corresponding to the optical condition where the wavelength of the light source is 405 nm, the numerical aperture of the objective lens is 0.65, and the thickness of the protection layer of the optical recording medium is 0.6 mm, since both of the in-plane birefringence and the vertical birefringence considerably deteriorate the amount of light received by the optical detector, it is required to correct the influences of them. That is, it is required to correct both of the influence of the in-plane birefringence and the influence of the vertical birefringence of the protection layer of the optical recording medium, the in-plane birefringence and vertical birefringence varying depending on the type of the optical recording medium. However, the optical head device disclosed in Japanese Laid-Open Patent Application JP-P2006-196156A has a function for correcting the influence of the vertical birefringence of a protection layer of an optical recording medium, the vertical birefringence varying depending on the type of the optical recording medium, but does not have a function for correcting the influence of the in-plane birefringence of the protection layer of the optical recording medium, the in-plane birefringence being different depending on the type of the optical recording medium.

In addition, Japanese Laid-Open Patent Application JP-P2004-273089A discloses a technique of an optical pick-up device which irradiates a light to the recording surface of an information recording medium and receiving the light reflected from the recording surface. This optical pick-up device includes a light source, an optical system, superimposing means, and phase difference signal output means. The optical system includes an objective lens, an optical element, and a polarization branch optical element. The objective lens focuses light fluxes emitted from the light source on the recording surface of an information recording medium. The optical element is arranged on a light path between the light source and the objective lens, and gives an optical phase difference based on an applied voltage to an incident light flux. The polarization branch optical element is arranged on a light path including the objective lens and the optical element of a returning light flux reflected on the recording surface, and branches the returning light flux from the light path. The superimposing means superimposes a predetermined alternating-current signal on a voltage applied to the optical element. The phase difference signal output means has at least one optical detector including a first optical detector for receiving the returning light flux branched by the polarization branch optical element, and outputs a signal including information related to an error of the optical phase difference in the returning light flux.

Moreover, Japanese Laid-Open Patent Application JP-P2005-332435A discloses an optical head device includes a light source, an objective lens, an optical detector, a light separation element, a birefringence correction element, and a birefringence correction element. The objective lens focuses a light emitted from the light source on an optical recording medium. The optical detector receives the light reflected from the optical recording medium. The light separation element separates the light emitted from the light source from the light reflected from the optical recording medium. The birefringence correction element corrects the influence of the birefringence of the protection layer of the optical recording medium on the emission light and the reflection light. The birefringence correction element has an optical axis, and the direction of the optical axis changes depending on the position of the birefringence correction element in the plane and also the phase difference between a polarization component of the direction parallel to the optical axis and a polarization component of the direction perpendicular to the optical axis changes depending on the position of the birefringence correction element in the plane.

### DISCLOSURE OF INVENTION

An object of the present invention is to solve the above-mentioned problems in conventional optical head devices and to provide an optical head device and an optical information recording/reproducing device for correcting an influence of the in-plane birefringence and an influence of the vertical birefringence of a protection layer of an optical recording medium, the in-plane birefringence and vertical birefringence varying depending on the type of the optical recording medium. In addition, an object of the present invention is to provide an optical head device and an optical information recording/reproducing device that are able to obtain a high signal-to-noise ratio.

In an aspect of the present invention, an optical head device includes an objective lens, an optical detector, a light separation part, single birefringence correction means. The objective lens focuses emission light emitted from a light source on plural types of optical recording media which are different from each other in an optical condition for use or an optical characteristic of a recording mark. The optical detector receives reflection light reflected by the optical recording medium. The light separation part separates the emission light emitted from the light source and the reflection light from the optical recording medium. The single birefringence correction means is arranged between the light separation part and the objective lens, and corrects the influence of the in-plane birefringence and the influence of the vertical birefringence of a protection layer of the optical recording medium, the in-plane birefringence and vertical birefringence which are different depending on the type of the optical recording medium.

In another aspect of the present invention, an optical information recording/reproducing device includes the above-mentioned optical head device and a drive circuit for driving the birefringence correction means. The drive circuit drives the birefringence correction means to correct the influence of the in-plane birefringence and the influence of the vertical birefringence of the protection layer of the optical recording medium, the in-plane birefringence and vertical birefringence are different depending on the type of the optical recording medium.

In further another view point of the present invention, an optical information recording/reproducing method includes a light focus step, a light detection step, a light separation step, and a correction step. At the light focus step, emission light emitted by a light source is collected on plural types of optical recording media which are different from each other in an optical condition for use or an optical characteristic of a recording mark. At the light detection step, reflection light reflected by the optical recording medium is received and detected. At the light separation step, the emission light and the reflection light are separated. At the correction step, the influence of the in-plane birefringence and the influence of the vertical birefringence of a protection layer of the optical recording medium, the in-plane birefringence and vertical birefringence which are different depending on the type of the optical recording medium, is corrected by single birefringence correction means.

### BRIEF DESCRIPTION OF DRAWINGS

The objects, effects, and features of the above-mentioned invention are more clarified on the basis of descriptions of exemplary embodiments in relation with attached drawings, in which:

FIG. 1 is a view showing a configuration of a conventional optical head device;

FIG. 2 is a cross sectional view of a birefringence correction element used for a conventional optical head device;

FIGS. 3A and 3B are plane views showing an electrode of a birefringence correction element used for a conventional optical head device and a cross sectional view of liquid crystal polymers;

FIGS. 4A and 4B are plane views showing an electrode of a birefringence correction element used for a conventional optical head device and a cross sectional view of liquid crystal polymers;

FIG. 5 is a view showing a calculation example of the relationship between the in-plane birefringence of a protection layer of an optical recording medium and the amount of light received by an optical detector;

FIG. 6 is a view showing a calculation example of the relationship between the vertical birefringence of a protection layer of an optical recording medium and the amount of light received by an optical detector;

FIG. 7 is a view showing a calculation example of the relationship between the in-plane birefringence of a protection layer of an optical recording medium and the amount of light received by an optical detector;

FIG. 8 is a view showing a calculation example of the relationship between the vertical birefringence of a protection layer of an optical recording medium and the amount of light received by an optical detector;

FIG. 9 is a view showing a configuration of an optical head device according to a first exemplary embodiment of the present invention;

FIG. 10 is a cross sectional view of a birefringence correction element used for an optical head device according to the first exemplary embodiment of the present invention;

FIGS. 11A and 11B are plane views showing an electrode of a birefringence correction element of an optical head device according to the first exemplary embodiment of the present invention and a cross sectional view of liquid crystal polymers;

FIGS. 12A and 12B are plane views showing an electrode of a birefringence correction element of an optical head device according to the first exemplary embodiment of the present invention and a cross sectional view of liquid crystal polymers;

FIGS. 13A to 13D are plane views of another electrode of a birefringence correction element of an optical head device according to the first exemplary embodiment of the present invention and cross sectional views of liquid crystal polymers;

FIGS. 14A to 14D are plane views of another electrode of a birefringence correction element of an optical head device according to the first exemplary embodiment of the present invention and cross sectional views of liquid crystal polymers;

FIGS. 15A to 15D are plane views of another electrode of a birefringence correction element of an optical head device according to the first exemplary embodiment of the present invention and cross sectional views of liquid crystal polymers;

FIG. 16 is a cross sectional view of a birefringence correction element used for an optical head device according to a second exemplary embodiment of the present invention;

FIGS. 17A and 17B are plane views of an electrode of a birefringence correction element according to the second exemplary embodiment of the present invention;

FIGS. 18A to 18D are plane views of an electrode of a birefringence correction element according to the second exemplary embodiment of the present invention and cross sectional views of liquid crystal polymers;

FIGS. 19A to 19D are plane views of an electrode of a birefringence correction element according to the second exemplary embodiment of the present invention and cross sectional views of liquid crystal polymers;

FIG. 20 is a view showing a configuration of an optical head device according to a third exemplary embodiment of the present invention;

FIGS. 21A and 21B are cross sectional views of a birefringence correction element used for an optical head device according to the third exemplary embodiment of the present invention;

FIGS. 22A and 22B are plane views of an electrode of a birefringence correction element of an optical head device according to the third exemplary embodiment of the present invention;

FIGS. 23A to 23D are plane views of an electrode of a birefringence correction element of an optical head device according to the third exemplary embodiment of the present invention and cross sectional views of liquid crystal polymers;

FIGS. 24A to 24D are plane views of an electrode of a birefringence correction element of an optical head device according to the third exemplary embodiment of the present invention and cross sectional views of liquid crystal polymers;

FIGS. 25A and 25B are views showing calculation examples of the relationship between the in-plane birefringence of a protection layer of an optical recording medium and the asymmetry of a reproduction signal;

FIG. 26 is a view showing a configuration of an optical information recording/reproducing device according to a fifth exemplary embodiment of the present invention; and

FIG. 27 is a view showing a configuration of an optical information recording/reproducing device according to a sixth exemplary embodiment of the present invention.

### BEST MODE FOR CARRYING OUT THE INVENTION

Referring to drawings, exemplary embodiments of the present invention will be explained below.

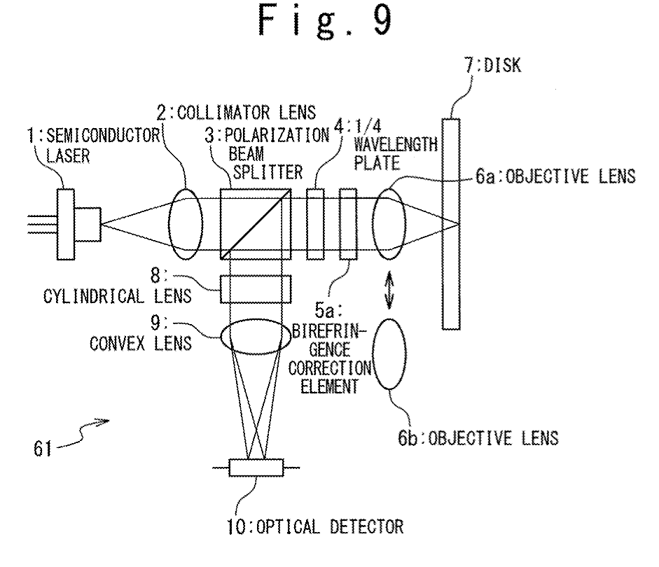

FIG. 9 shows a configuration of an optical head device according to a first exemplary embodiment of the present invention. The optical head device 61 includes a semiconductor laser 1, a collimator lens 2, a polarization beam splitter 3, a ¼ wavelength plate 4, a birefringence correction element 5a, objective lenses 6a and 6b, a cylindrical lens 8, a convex lens 9, and an optical detector 10.

Light emitted from the semiconductor laser 1 which serves as a light source is converted from divergent light into parallel light by the collimator lens 2, is incident on the polarization beam splitter 3 as P-polarization and transmits through the splitter at a rate of nearly 100%, is converted from linearly-polarized light into circularly-polarized light by the ¼ wavelength plate 4, transmits through the birefringence correction element 5a which serves as birefringence correction means, is converted from parallel light into convergent light by the objective lens 6a or the objective lens 6b, and is focused on a disk 7 which serves as an optical recording medium. Light reflected from the disk 7 is converted from divergent light into parallel light by the objective lens 6a or the objective lens 6b, transmits through the birefringence correction element 5a, is converted from circularly-polarized light into linearly-polarized light whose polarization direction is orthogonal to that of the linearly-polarized light in an outward path by the ¼ wavelength plate 4, is incident on the polarization beam splitter 3 as S-polarization and is reflected by the splitter at a rate of nearly 100%, is given the astigmatism by the cylindrical lens 8, is converted from parallel light into convergent light by the convex lens 9, and is received by the optical detector 10.

On the basis of an output from a light-receiving part of the optical detector 10, a focus error signal, a track error signal, and a reproduction signal that is a mark/space signal recorded on the disk 7 are detected. The focus error signal is detected with the common astigmatic method. The track error signal is detected with the common phase-contrast method in a case where the disk 7 is a reproduction dedicated disk or with the common push-pull method in a case where the disk 7 is a write-once or a rewritable disk.

The present exemplary embodiment will be explained by employing: an optical recording medium corresponding to an optical condition where the wavelength of the light source is 405 nm, the numerical aperture of the objective lens is 0.85, and the thickness of the protection layer of the optical recording medium is 0.1 mm; and an optical recording medium corresponding to an optical condition where the wavelength of the light source is 405 nm, the numerical aperture of the objective lens is 0.65, and the thickness of the protection layer of the optical recording medium is 0.6 mm as the target for usage, and the optical head device 61 is able to carry out recording and reproducing to both of the optical recording media. The wavelength of the light source is 405 nm. The objective lens 6a is designed so as not to cause a spherical aberration when parallel light is incident on the lens under the optical condition where the wavelength of the light source is 405 nm and the thickness of the protection layer of the optical recording medium is 0.1 mm, and the numerical aperture of the objective lens is 0.85. The objective lens 6b is designed so as not to cause the spherical aberration when parallel light is incident on the lens under the optical condition where the wavelength of the light source is 405 nm and the thickness of the protection layer of the optical recording medium is 0.6 mm, and the numerical aperture of the objective lens is 0.65.

The optical head device 61 includes an objective lens switching mechanism (not shown in the drawing) for switching an objective lens to be used between the objective lens 6a and the objective lens 6b depending on the type of the optical recording medium. As the disk 7, in the case of using an optical recording medium corresponding to the optical condition where the wavelength of the light source is 405 nm, the numerical aperture of the objective lens is 0.85, and the thickness of the protection layer of the optical recording medium is 0.1 mm, the objective lens switching mechanism is driven to arrange the objective lens 6a in a light path. As the disk 7, in the case of using an optical recording medium corresponding to the optical condition where the wavelength of the light source is 405 nm, the numerical aperture of the objective lens is 0.65, and the thickness of the protection layer of the optical recording medium is 0.6 mm, the objective lens switching mechanism is driven to arrange the objective lens 6b in a light path.

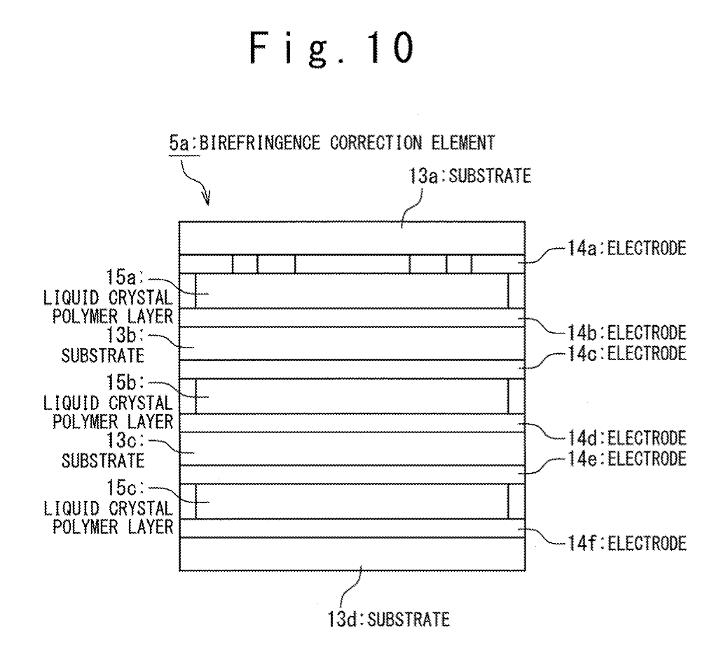

FIG. 10 is a cross sectional view of the birefringence correction element 5a. The birefringence correction element 5a is configured by sandwiching a liquid crystal polymer layer 15a between a substrate 13a and a substrate 13b, sandwiching a liquid crystal polymer layer 15b between a substrate 13b and a substrate 13c, and sandwiching a liquid crystal polymer layer 15c between a substrate 13c and a substrate 13d. An electrode 14a and an electrode 14b for applying an alternating-current voltage to the liquid crystal polymer layer 15a are formed on a surface of the substrate 13a facing to the liquid crystal polymer layer 15a and a surface of the substrate 13b facing to the liquid crystal polymer layer 15a, respectively. An electrode 14c and an electrode 14d for applying an alternating-current voltage to the liquid crystal polymer layer 15b are formed on a surface of the substrate 13b facing to the liquid crystal polymer layer 15b and a surface of the substrate 13c facing to the liquid crystal polymer layer 15b, respectively. An electrode 14e and an electrode 14f for applying an alternating-current voltage to the liquid crystal polymer layer 15c are formed on a surface of the substrate 13c facing to the liquid crystal polymer layer 15c and a surface of the substrate 13d facing to the liquid crystal polymer layer 15c, respectively.

The electrode 14a is a pattern electrode, and the electrode 14b to the electrode 14f are whole surface electrodes. The liquid crystal polymer layer 15a, the electrode 14a, and the electrode 14b constitute a first birefringence correction part. The liquid crystal polymer layer 15b, the electrode 14c, and the electrode 14d constitute a second birefringence correction part. The liquid crystal polymer layer 15c, the electrode 14e, and the electrode 14f constitute a third birefringence correction part. The first birefringence correction part corrects influence of the vertical birefringence of a protection layer of the disk 7, and both of the second birefringence correction part and the third birefringence correction part correct the influence of the in-plane birefringence of the protection layer of the disk 7.

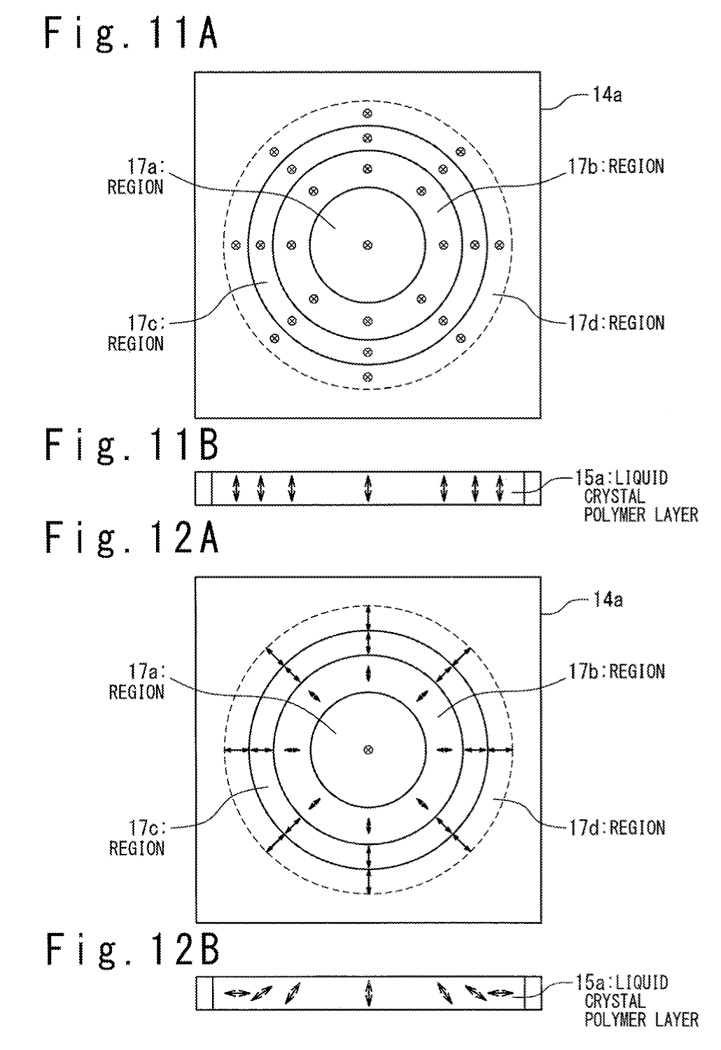

FIGS. 11A to 11B and FIGS. 12A to 12B are plane views of the electrode 14a of the first birefringence correction part and cross sectional views of the liquid crystal polymer layer 15a. The electrode 14a is divided into four regions, a region 17a to a region 17d, by three concentric circles including an optical axis as the center. In this manner, effective values of the alternating-current voltage applied to the liquid crystal polymer layer 15a can be set to the region 17a to the region 17d independently to each other. Meanwhile, dashed lines in the drawings show circles having the diameter equivalent to the effective diameter of the objective lens 6a and the objective lens 6b. For example, in a case where the effective diameter of the objective lens 6a and the objective lens 6b is 3.9 mm, the diameter of the circle separating the region 17a from the region 17b is 1.50 mm, the diameter of the circle separating the region 17b from the region 17c is 2.56 mm, and the diameter of the circle separating the region 17c from the region 17d is 3.28 mm. In addition, the arrowed lines in the drawings show longitudinal directions of liquid crystal polymers in the liquid crystal polymer layer 15a. The liquid crystal polymer layer 15a has a uniaxial refractive index anisotropy where the direction of the optical axis is the longitudinal direction of the liquid crystal polymer. When the reflective index of a polarization component (extraordinary component) along the direction parallel to the longitudinal direction of the liquid crystal polymer is ne and the reflective index of a polarization component (ordinary component) along the direction perpendicular to the longitudinal direction is no, the ne is larger than the no.

The longitudinal direction of the liquid crystal polymer in the liquid crystal polymer layer 15a makes a predetermined angle with the optical axis of the incident light in a surface including the optical axis of the incident light. When this angle is θ1, the angle θ1 varies depending on the effective value of the alternating-current voltage applied between the electrode 14a and the electrode 14b. On this occasion, when light transmits through the liquid crystal polymer layer 15a, a predetermined phase difference is generated between a polarization component of the radius direction of a circle including the optical axis of the incident light as the center and a polarization component of the tangential direction of the circle including the optical axis of the incident light as the center. When this phase difference is φ1, the phase difference φ1 is determined on the basis of the wavelength of the incident light, the thickness of a layer of the liquid crystal polymer layer 15a, ne-no, and θ1. When the effective value of the alternating-current voltage applied between the electrode 14a and the electrode 14b is Veff1, Veff1 is approximately proportional to φ1 in a case where Veff1 is within a certain range. For example, the range of Veff1 where Veff1 is approximately proportional to φ1 is 1.5V to 3.5V, and the liquid crystal polymer layer 15a can be designed so that φ1 can be equal to 0° when Veff1 is equal to 3.5V and φ1 can be equal to −180° when Veff1 is equal to 1.5V. Meanwhile, θ1 is equal to 0° when φ1 is equal to 0°, θ1 becomes larger as the value of φ1 becomes larger.

As the disk 7, in the case of using an optical recording medium corresponding to the optical condition where the wavelength of the light source is 405 nm, the numerical aperture of the objective lens is 0.85, and the thickness of the protection layer of the optical recording medium is 0.1 mm, Veff1 is equal to 3.5V in each of the region 17a to the region 17d. On this occasion, φ1 is equal to 0° to any one of the region 17a to the region 17d. In addition, as shown in FIGS. 11A and 11B, θ1 is equal to 0° in each of the region 17a to the region 17d. Accordingly, when a light transmits through the first birefringence correction part, a polarization state of the light does not change. As a result, the influence of the birefringence of the protection layer of the disk 7 is not corrected.

On the other hand, as the disk 7, in the case of using an optical recording medium corresponding to the optical condition where the wavelength of the light source is 405 nm, the numerical aperture of the objective lens is 0.65, and the thickness of the protection layer of the optical recording medium is 0.6 mm, Veff1 of 3.5V is applied to the region 17a, Veff1 of 3.3V is applied to the region 17b, Veff1 of 3.1V is applied to the region 17c, and Veff1 of 2.9V is applied to the region 17d. On this occasion, φ1 is equal to 0° in the region 17a, φ1 is equal to −18° in the region 17b, φ1 is equal to −36° in the region 17c, and φ1 is equal to −54° in the region 17d. In addition, as shown in FIGS. 12A and 12B, θ11 becomes larger from the region 17a toward the region 17d. Accordingly, when a light transmits through the first birefringence correction part, a predetermined change of the polarization state occurs. As a result, a change of the polarization state occurring because of the vertical birefringence of a protection layer of the disk 7 when a light transmits through the protection layer of the disk 7 is cancelled by a change of the polarization state occurring when the light transmits through the first birefringence correction part, and the influence of the vertical birefringence of the protection layer of the disk 7 is corrected. The above-mentioned value of φ1 corresponds to a case where the vertical birefringence of the protection layer of the disk 7 is 7×10⁻⁴.

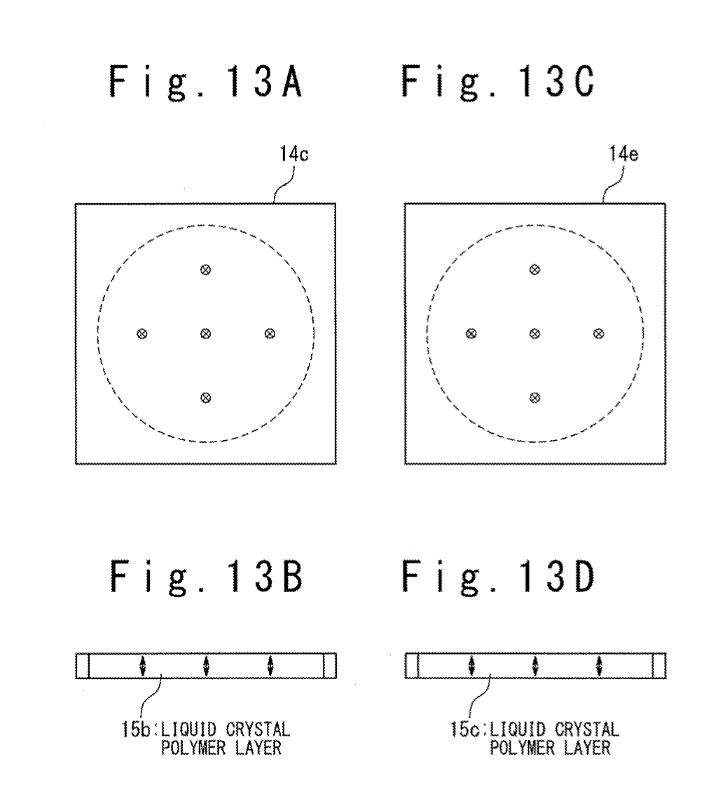

FIGS. 13A to 130, FIGS. 14A to 14D, and FIGS. 15A to 15D are plane views of the electrode 14c in a second birefringence correction part and cross sectional views of the liquid crystal polymer layer 15b, and are plane views of the electrode 14e in a third birefringence correction part and cross sectional views of the liquid crystal polymer layer 15c. Each of Figs. A is a plane view of the electrode 14c, each of Figs. B is a cross sectional view of the liquid crystal polymer layer 15b, each of Figs. C is a plane view of the electrode 14e, and each of Figs. D is a cross sectional view of the liquid crystal polymer layer 15c. Dashed lines in the drawings show circles having the diameter equivalent to the effective diameter of the objective lens 6a and the objective lens 6b. In addition, arrowed lines in the drawings show longitudinal directions of liquid crystal polymers in the liquid crystal polymer layer 15b and the liquid crystal polymer layer 15c. The liquid crystal polymer layer 15b and the liquid crystal polymer layer 15c have a uniaxial refractive index anisotropy where the direction of the optical axis is the longitudinal direction of the liquid crystal polymer. When the reflective index of the polarization component (extraordinary component) along the direction parallel to the longitudinal direction of the liquid crystal polymer is ne and the reflective index of the polarization component (ordinary component) along the direction perpendicular to the longitudinal direction is no, the ne is larger than the no.

Here, an X axis is defined to a horizontal direction of the plane view of the electrode 14c and the plane view of the electrode 14e, a Y axis is defined to a vertical direction, and a Z axis is defined to the optical axis direction of the incident light. The longitudinal direction of the liquid crystal polymer in the liquid crystal polymer layer 15b makes a predetermined angle with the Z axis in a X-Z plane. When this angle is θ2, the angle θ2 varies depending on the effective value of the alternating-current voltage applied between the electrode 14c and the electrode 14d. On this occasion, when a light transmits through the liquid crystal polymer layer 15b, a predetermined phase difference is generated between a polarization component of the X axis direction and a polarization component of the Y axis direction. When this phase difference is φ2, the phase difference φ2 is determined on the basis of the wavelength of the incident light, the thickness of the layer of the liquid crystal polymer layer 15b, ne-no, and θ2. When the effective value of the alternating-current voltage applied between the electrode 14c and the electrode 14d is Veff2, Veff2 is approximately proportional to φ2 in a case where Veff2 is within a certain range. For example, the range of Veff2 where Veff2 is approximately proportional to φ2 is 1.5V to 3.5V, and the liquid crystal polymer layer 15b can be designed so that φ2 can be equal to 0° when Veff2 is equal to 3.5V and φ2 can be equal to −180° when Veff2 is equal to 1.5V. Meanwhile, θ2 is equal to 0° when φ2 is equal to 0°, θ2 becomes larger as the absolute value of φ2 becomes larger.

Meanwhile, the longitudinal direction of the liquid crystal polymer in the liquid crystal polymer layer 15c makes a predetermined angle with the Z axis in the Y-Z plane. When this angle is θ3, the angle θ3 varies depending on the effective value of the alternating-current voltage applied between the electrode 14e and the electrode 14f. On this occasion, when a light transmits through the liquid crystal polymer layer 15c, a predetermined phase difference is generated between a polarization component of the X-axis direction and a polarization component of the Y-axis direction. When this phase difference is φ3, the phase difference φ3 is determined on the basis of the wavelength of the incident light, the thickness of the layer of the liquid crystal polymer layer 15c, ne-no, and θ3. When the effective value of the alternating-current voltage applied between the electrode 14e and the electrode 14f is Veff3, Veff3 is approximately proportional to φ3 in a case where Veff3 is within a certain range. For example, the range of Veff3 where Veff3 is approximately proportional to φ3 is 1.5V to 3.5V, and the liquid crystal polymer layer 15c can be designed so that φ3 can be equal to 0° when Veff3 is equal to 3.5V and φ3 can be equal to 180° when Veff3 is equal to 1.5V. Meanwhile, θ3 is equal to 0° when φ3 is equal to 0°, θ3 becomes larger as the absolute value of φ3 becomes larger.

As the disk 7, in the case of using an optical recording medium corresponding to the optical condition where the wavelength of the light source is 405 nm, the numerical aperture of the objective lens is 0.85, and the thickness of the protection layer of the optical recording medium is 0.1 mm, Veff2 is equal to 3.5V and Veff3 is equal to 3.5V. In this case, φ2 is equal to 0° and φ3 is equal to 0°. In addition, as shown in FIGS. 13A to 13D, θ2 is equal to 0° and 93 is equal to 0°. Accordingly, when a light transmits through the second birefringence correction part and the third birefringence correction part, the polarization state of the light does not change. As a result, the influence of the birefringence of the protection layer of the disk 7 is not corrected.

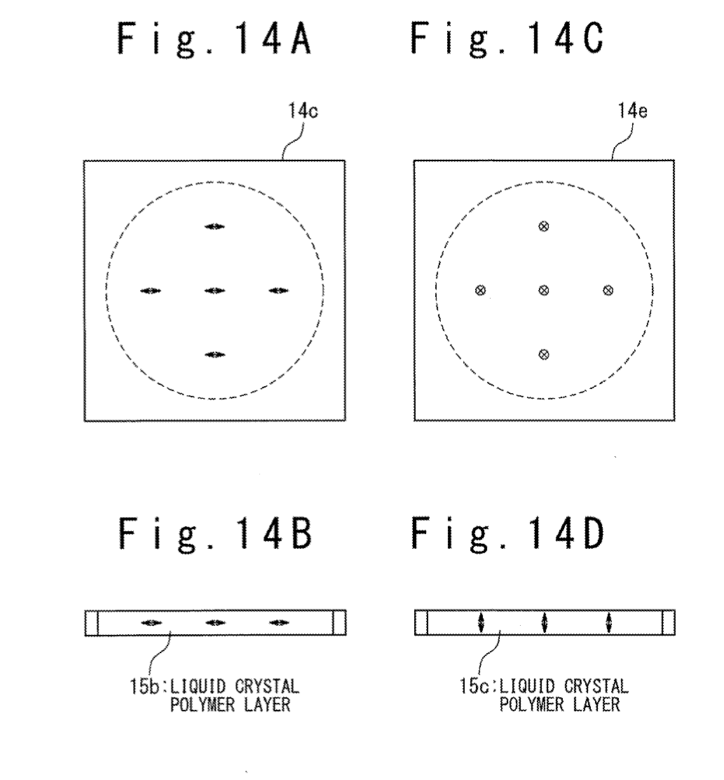

On the other hand, as the disk 7, in the case of using an optical recording medium corresponding to the optical condition where the wavelength of the light source is 405 nm, the numerical aperture of the objective lens is 0.65, and the thickness of the protection layer of the optical recording medium is 0.6 mm, Veff2 is equal to 2.9 V and Veff3 is equal to 3.5V when the in-plane birefringence of the protection layer of the disk 7 is negative, for example. On this occasion, φ2 is equal to −54° and φ3 is equal to 0°. In addition, as shown in FIGS. 14A to 14D, θ2 is not equal to 0° and θ3 is equal to 0°. Accordingly, when a light transmits through the second birefringence correction part, a predetermined change of the polarization state occurs and when the light transmits through the third birefringence correction part, the change of the polarization state does not occur. As a result, the change of the polarization state occurring because of the negative in-plane birefringence of the protection layer of the disk 7 when a light transmits through the protection layer of the disk 7 is cancelled by the change of the polarization state occurring when the light transmits through the second birefringence correction part, and the influence of the in-plane birefringence of the protection layer of the disk 7 is corrected. The above-mentioned value of φ2 corresponds to a case where the in-plane birefringence of the protection layer of the disk 7 is −1×10⁻⁴.

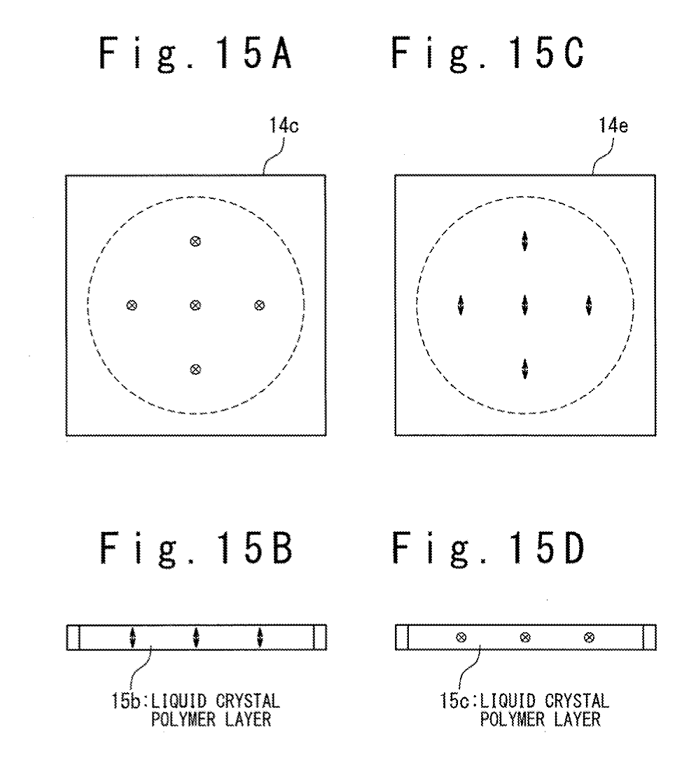

Meanwhile, Veff2 is equal to 3.5V and Veff3 is equal to 2.9 V when the in-plane birefringence of the protection layer of the disk 7 is positive, for example. On this occasion, φ2 is equal to 0° and φ3 is equal to 54°. In addition, as shown in FIGS. 15A to 15D, θ2 is equal to 0° and θ3 is not equal to 0°. Accordingly, when a light transmits through the second birefringence correction part, the change of the polarization state does not occur and when the light transmits through the third birefringence correction part, the predetermined change of the polarization state occurs. As a result, the change of the polarization state occurring because of the positive in-plane birefringence of the protection layer of the disk 7 when a light transmits through the protection layer of the disk 7 is cancelled by the change of the polarization state occurring when the light transmits through the third birefringence correction part, and the influence of the in-plane birefringence of the protection layer of the disk 7 is corrected. The above-mentioned value of φ3 corresponds to a case where the in-plane birefringence of the protection layer of the disk 7 is 1×10⁻⁴.

As explained above, both of the influence of the in-plane birefringence of and the influence of the vertical birefringence of a protection layer of the disk 7, which vary depending on the type of the disk 7, can be corrected by the birefringence correction element 5a. Accordingly, in the present exemplary embodiment, decrease of the amount of light received by the optical detector 10 caused by the in-plane birefringence of the protection layer of the disk 7 and decrease of the amount of light received by the optical detector 10 caused by the vertical birefringence of the protection layer of the disk 7 do not occur in reproducing information from the disk 7, and accordingly a high signal-to-noise ratio can be obtained.

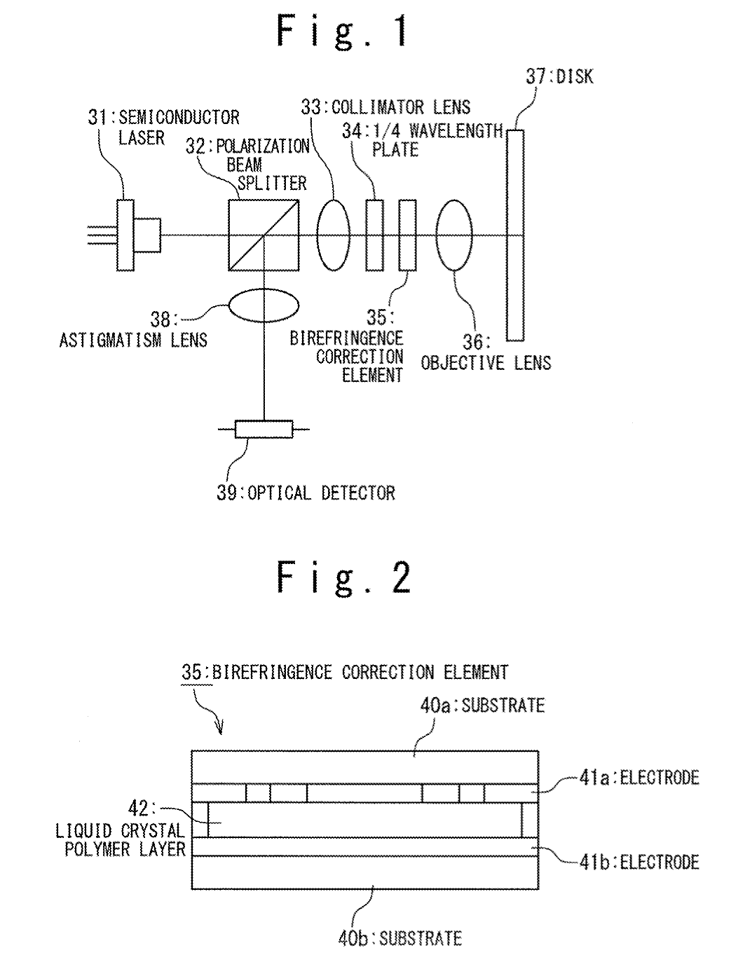

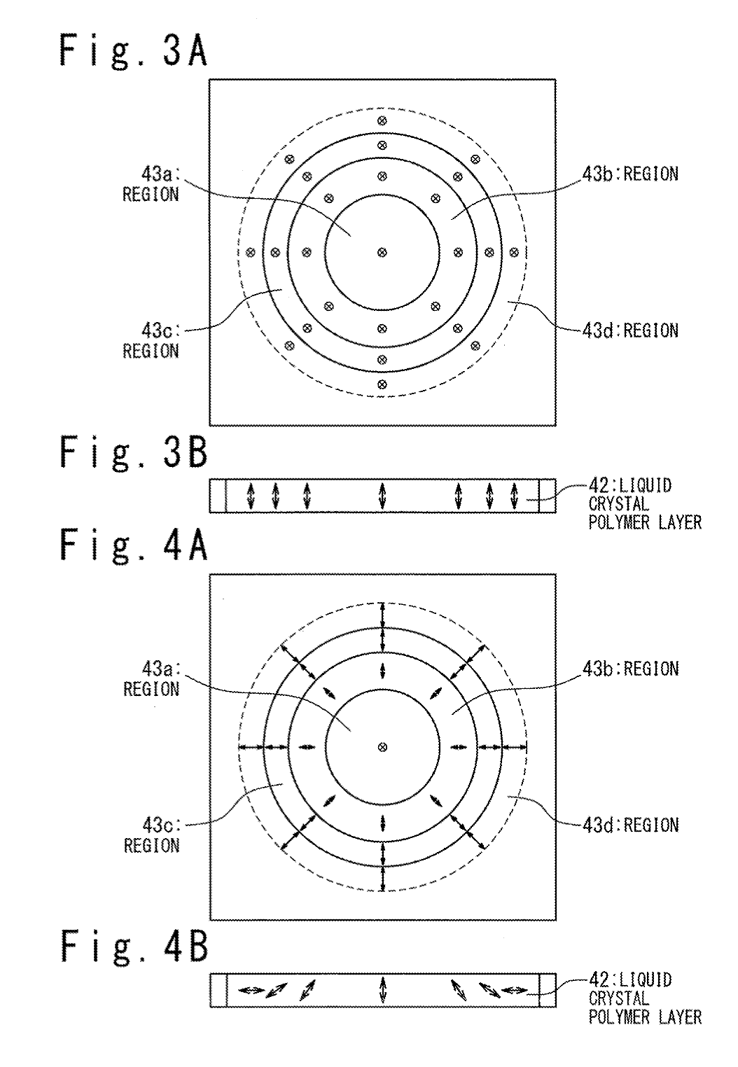

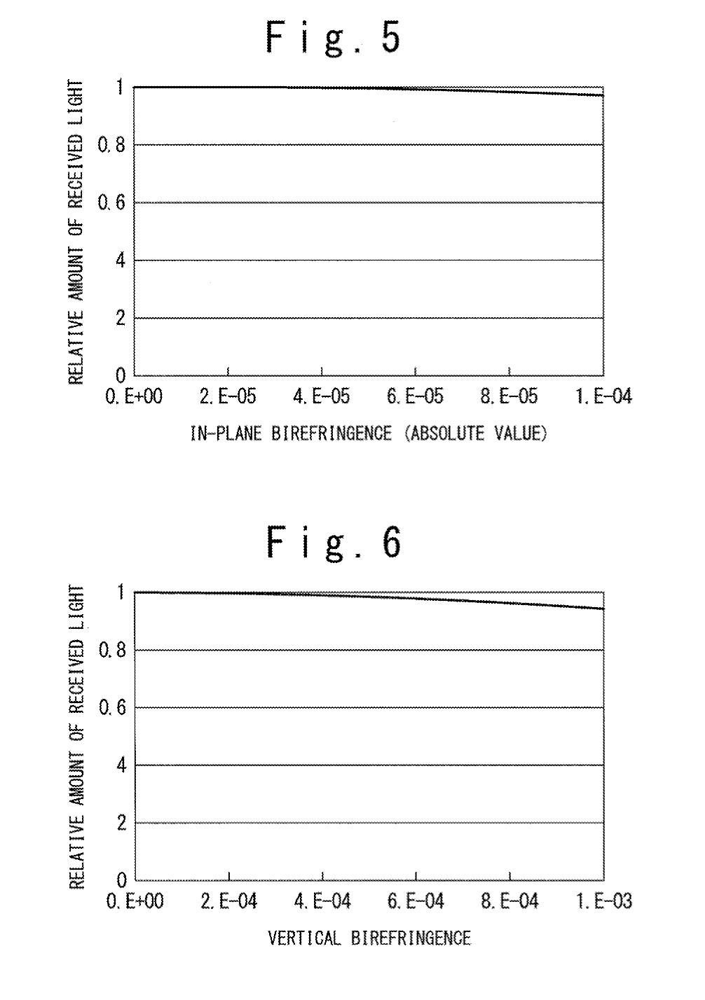

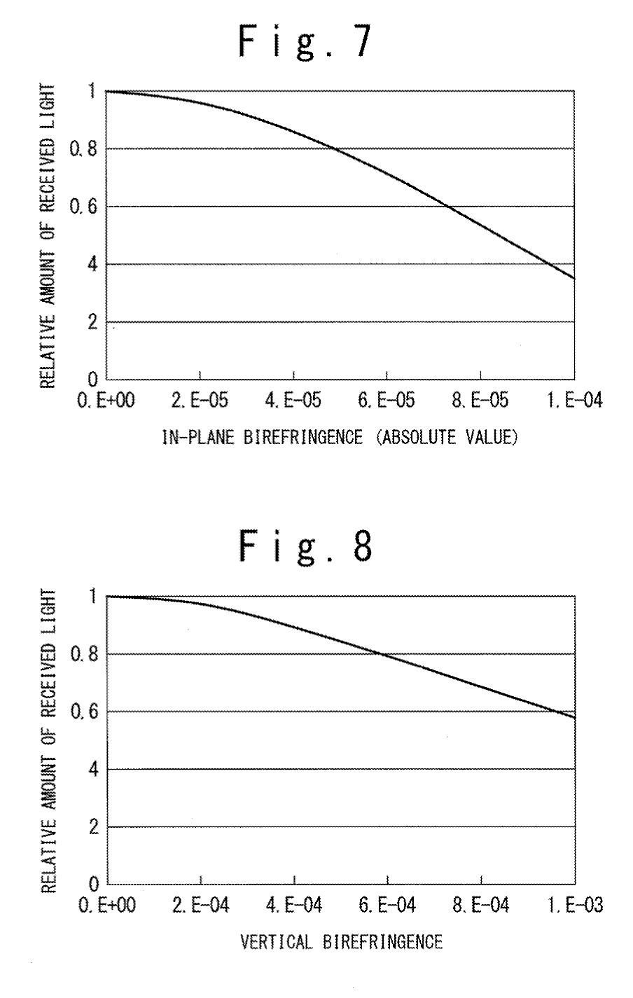

In an optical head device according to a second exemplary embodiment of the present invention, the birefringence correction element 5a of the optical head device 61 explained in the first exemplary embodiment is replaced by a birefringence correction element 5b. The configuration is the same as that shown in FIG. 1.

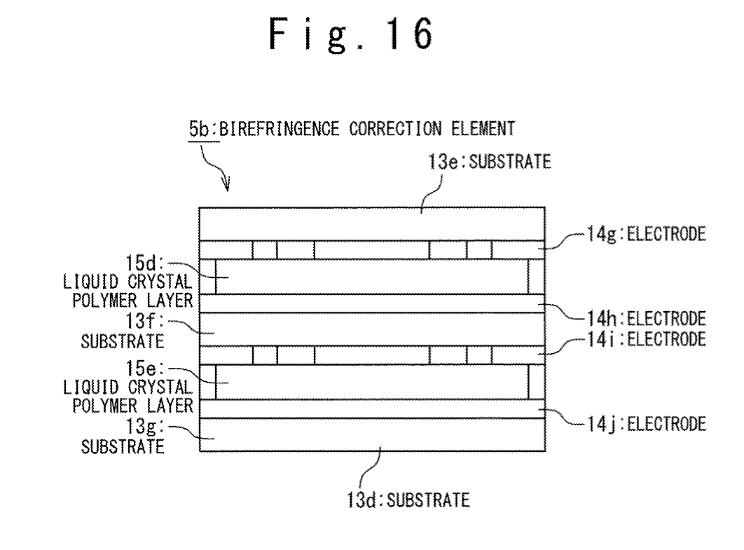

FIG. 16 is a cross sectional view of the birefringence correction element 5b. The birefringence correction element 5b is configured by sandwiching a liquid crystal polymer layer 15d between a substrate 13e and a substrate 13f and sandwiching a liquid crystal polymer layer 15e between a substrate 13f and a substrate 13g. An electrode 14g and an electrode 14h for applying an alternating-current voltage to the liquid crystal polymer layer 15d are formed on a surface of the substrate 13e facing to the liquid crystal polymer layer 15d and a surface of the substrate 13f facing to the liquid crystal polymer layer 15d, respectively. An electrode 14i and an electrode 14j for applying an alternating-current voltage to the liquid crystal polymer layer 15e are formed on a surface of the substrate 13f facing to the liquid crystal polymer layer 15e and a surface of the substrate 13g facing to the liquid crystal polymer layer 15e, respectively. The electrode 14g and the electrode 14i are pattern electrodes, and the electrode 14h and the electrode 14j are whole surface electrodes. The liquid crystal polymer layer 15d, the electrode 14g, and the electrode 14h constitute a first birefringence correction part. The liquid crystal polymer layer 15e, the electrode 14i, and the electrode 14j constitute a second birefringence correction part. Both of the first birefringence correction part and the second birefringence correction part correct the influence of the in-plane birefringence of and the influence of the vertical birefringence of the protection layer of the disk 7.

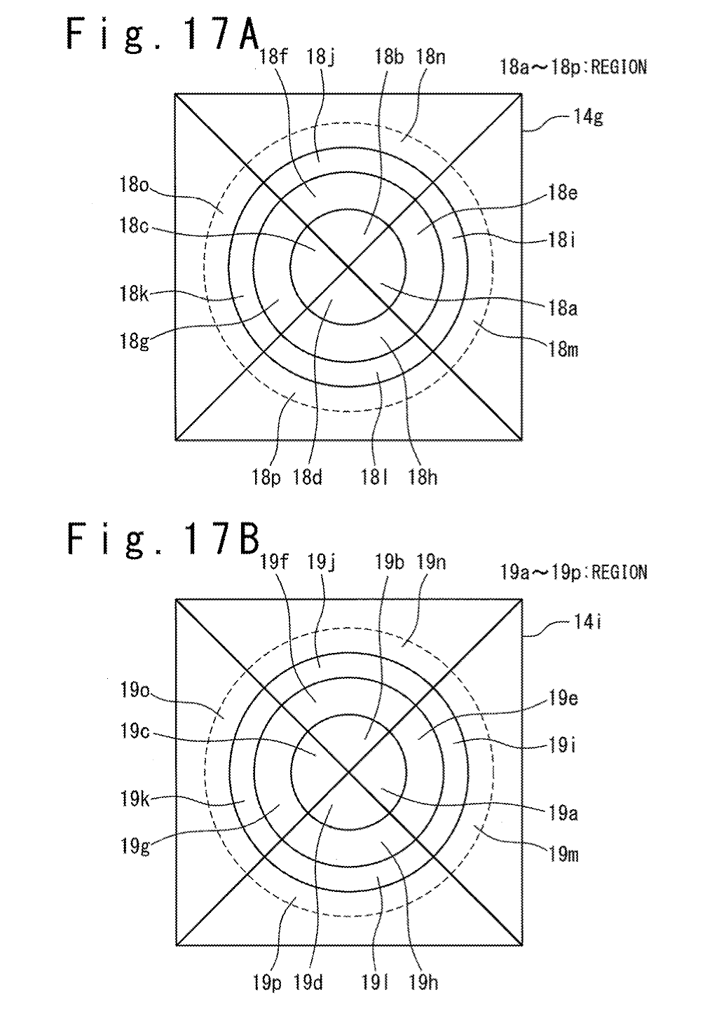

FIGS. 17A and 17B are a plane view of the electrode 14g of the first birefringence correction part and a plane view of the electrode 14i of the second birefringence correction part. As shown in FIG. 17A, the electrode 14g is divided into sixteen regions, a region 18a to a region 18p, by three concentric circles including an optical axis as the center and two straight lines passing the optical axis that are perpendicular to each other. In this manner, effective values of the alternating-current voltage applied to the liquid crystal polymer layer 15d can be set to the region 18a to the region 18p independently to each other. In addition, as shown in FIG. 17B, the electrode 14i is divided into sixteen regions, a region 19a to a region 19p, by three concentric circles including an optical axis as the center and two straight lines passing the optical axis that are perpendicular to each other. In this manner, effective values of the alternating-current voltage applied to the liquid crystal polymer layer 15e can be set to the region 19a to the region 19p independently to each other. Meanwhile, dashed lines in the drawings show circles having the diameter equivalent to effective diameters of the objective lens 6a and the objective lens 6b. For example, in a case where the effective diameters of the objective lens 6a and the objective lens 6b is 3.9 mm, diameters of the circle separating the region 18a to the region 18d from the region 18e to the region 18h and the circle separating the region 19a to the region 19d from the region 19e to the region 19h are designed to be 1.50 mm, diameters of the circle separating the region 18e to the region 18h from the region 18i to the region 18l and the circle separating the region 19e to the region 19h from the region 19i to the region 19l are designed to be 2.56 mm, and diameters of the circle separating the region 18i to the region 18l from the region 18m to the region 18p and the circle separating the region 19i to the region 19l from the region 19m to the region 19p are designed to be 3.28 mm.

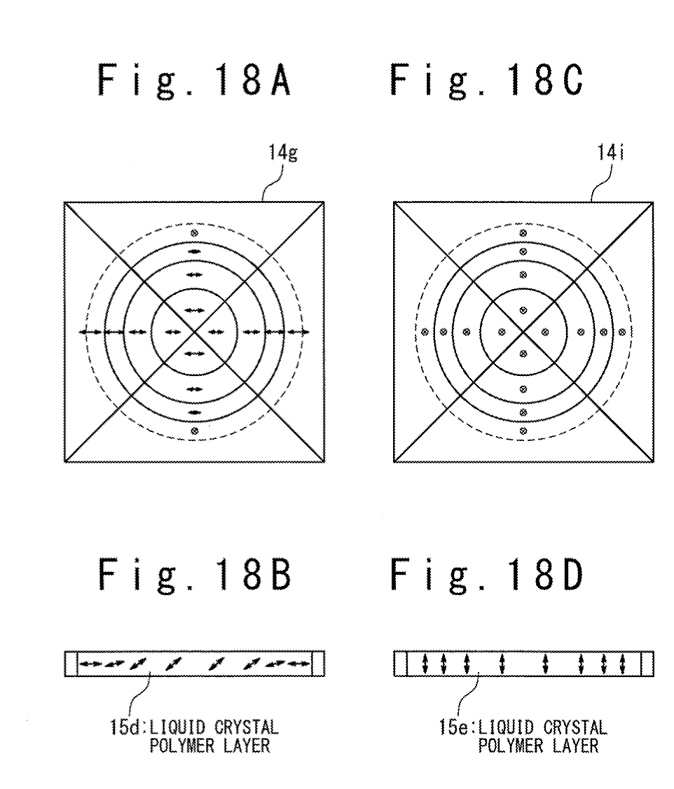

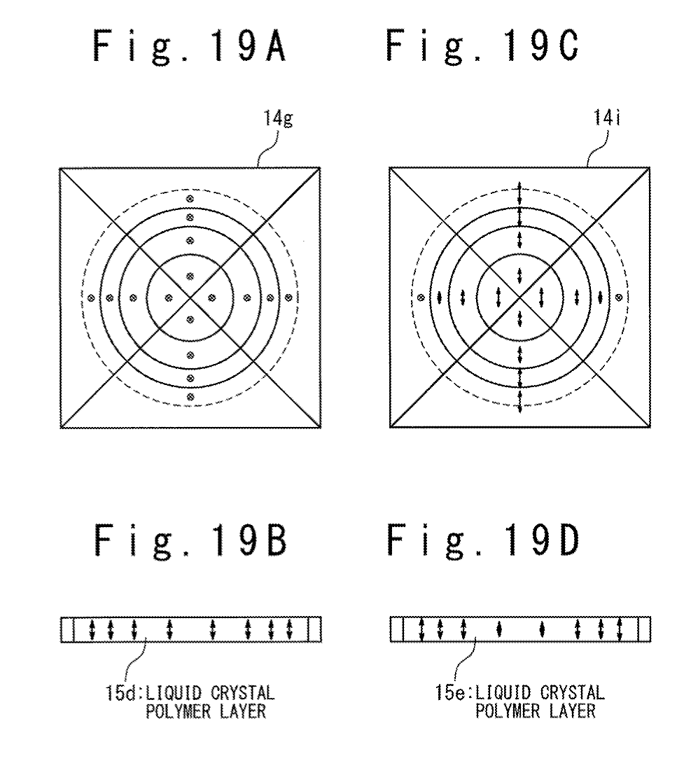

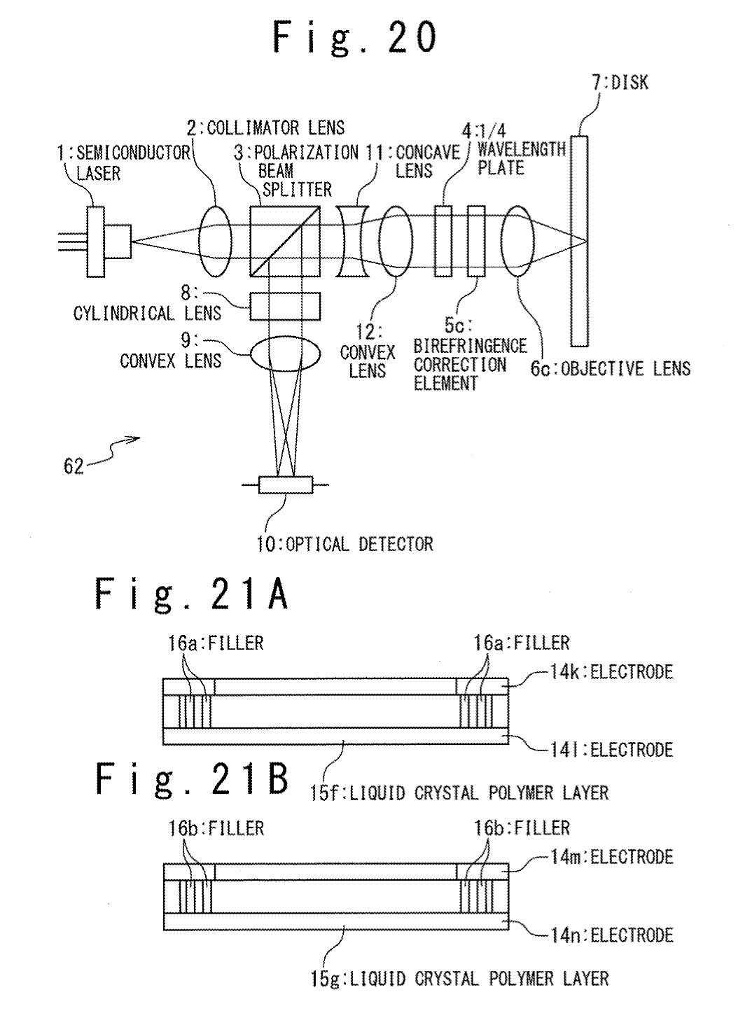

FIGS. 18A to 18D and FIGS. 19A to 19D are plane views of the electrode 14g of the first birefringence correction part and cross sectional views of the liquid crystal polymer layer 15d, and plane views of the electrode 14i of the second birefringence correction part and cross sectional views of the liquid crystal polymer layer 15e. Dashed lines in the drawings show circles having the diameter equivalent to effective diameters of the objective lens 6a and the objective lens 6b. In addition, arrowed lines in the drawings show longitudinal directions of liquid crystal polymers in the liquid crystal polymer layer 15d and the liquid crystal polymer layer 15e. The liquid crystal polymer layer 15d and the liquid crystal polymer layer 15e have a uniaxial refractive index anisotropy where the direction of the optical axis is the longitudinal direction of a liquid crystal polymer. When the reflective index of a polarization component (extraordinary component) along the direction parallel to the longitudinal direction of the liquid crystal polymer is ne and the reflective index of a polarization component (ordinary component) along the direction perpendicular to the longitudinal direction is no, the ne is larger than the no.

Here, an X axis is defined to a horizontal direction of the plane view of the electrode 14g and the plane view of the electrode 14i, a Y axis is defined to a vertical direction, and a Z axis is defined to the optical axis direction of the incident light. The longitudinal direction of the liquid crystal polymer in the liquid crystal polymer layer 15d makes a predetermined angle with the Z axis in a X-Z plane. When this angle is θ1, the angle θ1 varies depending on the effective value of the alternating-current voltage applied between the electrode 14g and the electrode 14h. On this occasion, when a light transmits through the liquid crystal polymer layer 15d, a predetermined phase difference is generated between a polarization component of the X axis direction and a polarization component of the Y axis direction. When this phase difference is φ1, the phase difference φ1 is determined on the basis of the wavelength of the incident light, the thickness of the layer of the liquid crystal polymer layer 15d, ne-no, and θ1. When the effective value of the alternating-current voltage applied between the electrode 14g and the electrode 14h is Veff1, Veff1 is approximately proportional to φ1 in a case where Veff1 is within a certain range. For example, the range of Veff1 where Veff1 is approximately proportional to φ1 is 1.5V to 3.5V, and the liquid crystal polymer layer 15d can be designed so that φ1 can be equal to 0° when Veff1 is equal to 3.5V and φ1 can be equal to −180° when Veff1 is equal to 1.5V. Meanwhile, θ1 is equal to 0° when φ1 is equal to 0°, θ1 becomes larger as the absolute value of φ1 becomes larger.

Meanwhile, the longitudinal direction of the liquid crystal polymer in the liquid crystal polymer layer 15e makes a predetermined angle with the Z axis in a Y-Z plane. When this angle is θ2, the angle θ2 varies depending on the effective value of the alternating-current voltage applied between the electrode 14i and the electrode 14j. On this occasion, when a light transmits through the liquid crystal polymer layer 15e, a predetermined phase difference is generated between a polarization component of the X axis direction and a polarization component of the Y axis direction. When this phase difference is φ2, the phase difference φ2 is determined on the basis of the wavelength of the incident light, the thickness of the layer of the liquid crystal polymer layer 15e, ne-no, and θ2. When the effective value of the alternating-current voltage applied between the electrode 14i and the electrode 14j is Veff2, Veff2 is approximately proportional to φ2 in a case where Veff2 is within a certain range. For example, the range of Veff2 where Veff2 is approximately proportional to φ2 is 1.5V to 3.5V, and the liquid crystal polymer layer 15e can be designed so that φ2 can be equal to 0° when Veff2 is equal to 3.5V and φ2 can be equal to 180° when Veff2 is equal to 1.5V. Meanwhile, θ2 is equal to 0° when φ2 is equal to 0°, θ2 becomes larger as the absolute value of φ2 becomes larger.

As the disk 7, in a case of using the optical recording medium corresponding to an optical condition where the wavelength of the light source is 405 nm, the numerical aperture of the objective lens is 0.85, and the thickness of the protection layer of the optical recording medium is 0.1 mm, Veff1 is equal to 3.5V to each of the region 18a to the region 18p and Veff2 is equal to 3.5V to each of the region 19a to the region 19p. In this case, φ1 is equal to 0° to each of the region 18a to the region 18p and φ2 is equal to 0° to each of the region 19a to the region 19p. In addition, θ1 is equal to 0° to each of the region 18a to the region 18p and θ2 is equal to 0° to each of the region 19a to the region 19p. Accordingly, when a light transmits through the first birefringence correction part and the second birefringence correction part, the polarization state of the light does not change. As a result, the influence of the birefringence of the protection layer of the disk 7 is not corrected.

On the other hand, as the disk 7, in the case of using an optical recording medium corresponding to an optical condition where the wavelength of the light source is 405 nm, the numerical aperture of the objective lens is 0.65, and the thickness of the protection layer of the optical recording medium is 0.6 mm, when the in-plane birefringence of the protection layer of the disk 7 is negative, Veff1 is equal to 3.5V to the region 18n and the region 18p, Veff1 is equal to 3.3V to the region 18j and the region 18l, Veff1 is equal to 3.1V to the region 18f and the region 18h, Veff1 is equal to 2.9 V to the region 18a to the region 18d, Veff1 is equal to 2.7V to the region 18e and the region 18g, Veff1 is equal to 2.5V to the region 18i and the region 18k, Veff1 is equal to 2.3V to the region 18m and the region 18o, and Veff2 is equal to 3.5V to the region 19a to the region 19p, for example. On this occasion, φ1 is equal to 0° to the region 18n and the region 18p, φ1 is equal to −18° to the region 18j and the region 18l, φ1 is equal to −36° to the region 18f and the region 18h, φ1 is equal to −54° to the region 18a to the region 18d, φ1 is equal to −72° to the region 18e and the region 18g, φ1 is equal to −90° to the region 18i and the region 18k, φ1 is equal to −108° to the region 18m and the region 18o, and φ2 is equal to 0° to the region 19a to the region 19p. In addition, as shown in FIG. 18A, the absolute value of θ1 becomes larger from the region 18n and the region 18p toward the region 18a to the region 18d, and further becomes larger from the region 18a to the region 18d toward the region 18m and the region 18o. And, θ2 is equal to 0°. Accordingly, when a light transmits through the first birefringence correction part, a predetermined change of the polarization state occurs and when the light transmits through the second birefringence correction part, the predetermined change of the polarization state does not occur. As a result, the change of the polarization state occurring because of the negative in-plane birefringence and vertical birefringence of the protection layer of the disk 7 when a light transmits through the protection layer of the disk 7 is cancelled by the change of the polarization state occurring when the light transmits through the first birefringence correction part, and the influence of the in-plane birefringence of and the influence of the vertical birefringence of the protection layer of the disk 7 are corrected. The above-mentioned value of φ1 corresponds to a case where the in-plane birefringence of the protection layer of the disk 7 is −1×10⁻⁴ and the vertical birefringence is 7×10⁻⁴.

Here, when a value of the phase difference φ1 corresponding to a case where the in-plane birefringence of the protection layer of the disk 7 is −1×10⁻⁴ and the vertical birefringence is 0 is φ1i and a value of the phase difference φ1 corresponding to a case where the in-plane birefringence of the protection layer of the disk 7 is 0 and the vertical birefringence is 7×10⁻⁴ is φ1v, φ1i is equal to −54° and φ1v is equal to 54° to the region 18n and the region 18p, φ1i is equal to −54° and φ1v is equal to 36° to the region 18j and the region 18l, φ1i is equal to −54° and φ1v is equal to 18° to the region 18f and the region 18h, φ1i is equal to −54° and φ1 v is equal to 0° to the region 18a to the region 18d, φ1i is equal to −54° and φ1v is equal to −18° to the region 18e and the region 18g, φ1i is equal to −54° and φ1v is equal to −36° to the region 18i and the region 18k, and φ1i is equal to −54° and φ1v is equal to −54° to the region 18m and the region 18o. The above-mentioned value of the phase difference φ1 is obtained with “φ1=φ1i+φ1v”.

Meanwhile, when the in-plane birefringence of the protection layer of the disk 7 is positive, Veff1 is equal to 3.5V to the region 18a to the region 18p, Veff2 is equal to 3.5V to the region 19m and the region 19o, Veff2 is equal to 3.3V to the region 19i and the region 19k, Veff2 is equal to 3.1V to the region 19e to the region 19d, Veff2 is equal to 2.9 V to the region 19a to the region 19d, Veff2 is equal to 2.7V to the region 19f and the region 19h, Veff2 is equal to 2.5V to he region 19j and the region 19l, and Veff2 is equal to 2.3V to the region 19n and the region 19p. On this occasion, φ1 is equal to 0° to the region 18a to the region 18p, φ2 is equal to 0° to the region 19m and the region 19o, φ2 is equal to 18° to the region 19l and the region 19k, φ2 is equal to 36° to the region 19e and the region 19g, φ2 is equal to 54° to the region 19a to the region 19d, φ2 is equal to 72° to the region 19f and the region 19h, φ2 is equal to 90° to the region 19j and the region 19l, and φ2 is equal to 108° to the region 19n and the region 19p. In addition, as shown in FIGS. 19A to 19D, θ1 is equal to 0°, and the absolute value of θ2 becomes larger from the region 19m and the region 19o toward the region 19a to the region 19d and further becomes larger from the region 19a to the region 19d toward the region 19n and the region 19p. Accordingly, when a light transmits through the first birefringence correction part, the predetermined change of the polarization state does not occur and when the light transmits through the second birefringence correction part, the predetermined change of the polarization state occurs. As a result, the change of the polarization state occurring because of the positive in-plane birefringence and the vertical birefringence of the protection layer of the disk when a light transmits through the protection layer of the disk 7 is cancelled by the change of the polarization state occurring when the light transmits through the second birefringence correction part, and the influence of the in-plane birefringence of and the influence of the vertical birefringence of the protection layer of the disk 7 are corrected. The above-mentioned value of φ2 corresponds to a case where the in-plane birefringence of the protection layer of the disk 7 is 1×10⁻⁴ and the vertical birefringence is 7×10⁻⁴.

Here, when a value of the phase difference φ2 corresponding to a case where the in-plane birefringence of the protection layer of the disk 7 is 1×10⁻⁴ and the vertical birefringence is 0 is φ2i and a value of the phase difference φ2 corresponding to a case where the in-plane birefringence of the protection layer of the disk 7 is 0 and the vertical birefringence is 7×10⁻⁴ is φ2v, φ2i is equal to 54′ and φ2v is equal to −54° to the region 19m and the region 19o, φ2i is equal to 54° and φ2v is equal to −36° to the region 19i and the region 19k, φ2i is equal to 54° and φ2v is equal to −18° to the region 19e and the region 19g, φ2i is equal to 54° and φ2v is equal to 0° to the region 19a to the region 19d, φ2i is equal to 54° and φ2v is equal to 18° to the region 19f and the region 19h, φ2i is equal to 54° and φ2v is equal to 36° to the region 19j and the region 19l, and φ2i is equal to 54° and φ2v is equal to 54° to the region 19n and the region 19p. The above-mentioned value of the phase difference φ2 is obtained with “φ2=φ2i+φ2v”.

As explained above, both of the influence of the in-plane birefringence of and the influence of the vertical birefringence of the protection layer of the disk 7, which vary depending on the type of the disk 7, can be corrected by the birefringence correction element 5b. Accordingly, in the present exemplary embodiment, decrease of the amount of light received by the optical detector 10 caused by the in-plane birefringence of the protection layer of the disk 7 and decrease of the amount of light received by the optical detector 10 caused by the vertical birefringence of the protection layer of the disk 7 do not occur in reproducing information from the disk 7, and accordingly a high signal-to-noise ratio can be obtained.

The number of the birefringence correction parts included in the birefringence correction element is three in the birefringence correction element 5a explained in the first exemplary embodiment, but the number is two in the birefringence correction element 5b explained in the second exemplary embodiment. Accordingly, since having the birefringence correction element of a simple configuration compared to the optical head device according to the first exemplary embodiment, the optical head device according to the second exemplary embodiment is suitable for the down sizing, the weight reducing, and the cost saving, and has an effect that a higher optical output can be obtained in the recording and a higher signal-to-noise ratio can be obtained in the reproducing since a loss of the light transmitting through the birefringence correction element is small.

FIG. 20 shows a configuration of an optical head device according to a third exemplary embodiment of the present invention. The optical head device 62 includes the semiconductor laser 1, the collimator lens 2, the polarization beam splitter 3, a concave lens 11, a convex lens 12, the ¼ wavelength plate 4, a birefringence correction element 5c, objective lenses 6c, the cylindrical lens 8, the convex lens 9, and the optical detector 10.

Light emitted from the semiconductor laser 1 which serves as a light source is converted from divergent light into parallel light by the collimator lens 2, is incident on the polarization beam splitter 3 as P-polarization and transmits through the splitter at a rate of nearly 100%, is converted from small-diameter parallel light into large-diameter parallel light or divergent light by the concave lens 11 and the convex lens 12, is converted from linearly-polarized light into circularly-polarized light by the ¼ wavelength plate 4, transmits through the birefringence correction element 5c which serves as birefringence correction means, is converted from the parallel light or the divergent light into convergent light by the objective lens 6c, and is focused on the disk 7 which serves as an optical recording medium. Light reflected from the disk 7 is converted from divergent light into parallel light or convergent light by the objective lens 6c, transmits through the birefringence correction element 5c, is converted from circularly-polarized light into linearly-polarized light whose polarization direction is orthogonal to that of the linearly-polarized light in an outward path by the ¼ wavelength plate 4, is converted from the large-diameter parallel light or the convergent light into the small diameter parallel light by the concave lens 11 and the convex lens 12, is incident on the polarization beam splitter 3 as S-polarization and is reflected by the splitter at a rate of nearly 100%, is given the astigmatism by the cylindrical lens 8, is converted from parallel light into convergent light by the convex lens 9, and is received by the optical detector 10. On the basis of an output from a light-receiving part of the optical detector 10, a focus error signal, a track error signal, and a reproduction signal that is a mark/space signal recorded on the disk 7 are detected. The focus error signal is detected with the common astigmatic method. The track error signal is detected with the common phase-contrast method in a case where the disk 7 is a reproduction dedicated disk or with the common push-pull method in a case where the disk 7 is a write-once or a rewritable disk.

The present exemplary embodiment will be explained by employing: an optical recording medium corresponding to an optical condition where the wavelength of the light source is 405 nm, the numerical aperture of the objective lens is 0.85, and the thickness of the protection layer of the optical recording medium is 0.1 mm; and an optical recording medium corresponding to an optical condition where the wavelength of the light source is 405 nm, the numerical aperture of the objective lens is 0.65, and the thickness of the protection layer of the optical recording medium is 0.6 mm as the target for usage, and the optical head device 62 is able to carry out recording and reproducing to both of the optical recording media. The wavelength of the light source is 405 nm. The objective lens 6c is designed so as not to cause the spherical aberration when parallel light is incident on the lens under the optical condition where the wavelength of the light source is 405 nm and the thickness of the protection layer of the optical recording medium is 0.1 mm, and is designed so as not to cause the spherical aberration when parallel light is incident on the lens under the optical condition where the wavelength of the light source is 405 nm and the thickness of the protection layer of the optical recording medium is 0.6 mm. In addition, the numerical aperture of the objective lens 6c is 0.85.

The concave lens 11 and the convex lens 12 have a function of correcting the spherical aberration for switching an incident light to the objective lens 6c between parallel light and divergent light having a predetermined divergent angle depending on the type of the optical recording medium. As the disk 7, in the case of using an optical recording medium corresponding to the optical condition where the wavelength of the light source is 405 nm, the numerical aperture of the objective lens is 0.85, and the thickness of the protection layer of the optical recording medium is 0.1 mm, a clearance between the concave lens 11 and the convex lens 12 is set so that light incident on the concave lens 11 as parallel light can be emitted from the convex lens 12 as parallel light. A concave and convex lenses drive mechanism that is not shown in the drawing moves one of the concave lens 11 and the convex lens 12 to the optical axis direction to set the clearance between the concave lens 11 and the convex lens 12. In the case of using as the disk 7 the optical recording medium corresponding to the optical condition where the wavelength of the light source is 405 nm, the numerical aperture of the objective lens is 0.65, and the thickness of the protection layer of the optical recording medium is 0.6 mm, the concave and convex lenses drive mechanism (not shown in the drawing) moves one of the concave lens 11 and the convex lens 12 to the optical axis direction so that light incident on the concave lens 11 as parallel light can be emitted from the convex lens 12 as divergent light having a predetermined divergent angle, and thus the clearance between the concave lens 11 and the convex lens 12 is set. In this manner, the spherical aberration is corrected depending on the type of the disk 7.

The birefringence correction element 5c is configured by replacing the second birefringence correction part and the third birefringence correction part included in the birefringence correction element 5a explained in the first exemplary embodiment by another second birefringence correction part and another third birefringence correction part, respectively. Here, the configuration and the function of the first birefringence correction part included in the birefringence correction element 5c are the same as the configuration and the function of the first birefringence correction part included in the birefringence correction element 5a. Accordingly, in the birefringence correction element 5c, the first birefringence correction part can correct the influence of the vertical birefringence of the protection layer of the disk 7, the vertical birefringence varying depending on the type of the disk 7, in the same manner as that of the birefringence correction element 5a.

FIGS. 21A and 21B are cross sectional views of the second birefringence correction part and the third birefringence correction part included in the birefringence correction element 5c. As shown in FIG. 21A, the second birefringence correction part is configured by sandwiching a liquid crystal polymer layer 15f between an electrode 14k and an electrode 14l for applying an alternating-current voltage to the liquid crystal polymer layer 15f, and as shown in FIG. 21B, the third birefringence correction part is configured by sandwiching a liquid crystal polymer layer 15g between an electrode 14m and an electrode 14n for applying an alternating-current voltage to the liquid crystal polymer layer 15g. The electrode 14k and the electrode 14m are pattern electrodes, and the electrode 14l and the electrode 14n are whole electrodes. In an outer portion of the circle having the diameter corresponding to the numerical aperture 0.65 of the objective lens 6c, a filling material 16a is filled between the electrode 14k and the electrode 14l together with the liquid crystal polymer layer 15f and a filling material 16b is filled between the electrode 14m and the electrode 14n together with the liquid crystal polymer layer 15g. The liquid crystal polymer layer 15f and the filling material 16a and the liquid crystal polymer layer 15g and the filling material 16b constitute diffractive gratings. The liquid crystal polymer layer 15f and the liquid crystal polymer layer 15g have a uniaxial refractive index anisotropy where the direction of the optical axis is the longitudinal direction of the liquid crystal polymer. When the reflective index of a polarization component (extraordinary component) along the direction parallel to the longitudinal direction of the liquid crystal polymer is ne and the reflective index of a polarization component (ordinary component) along the direction perpendicular to the longitudinal direction is no, the ne is larger than the no. In addition, reflective indexes of the filling material 16a and the filling material 16b are equivalent to no.

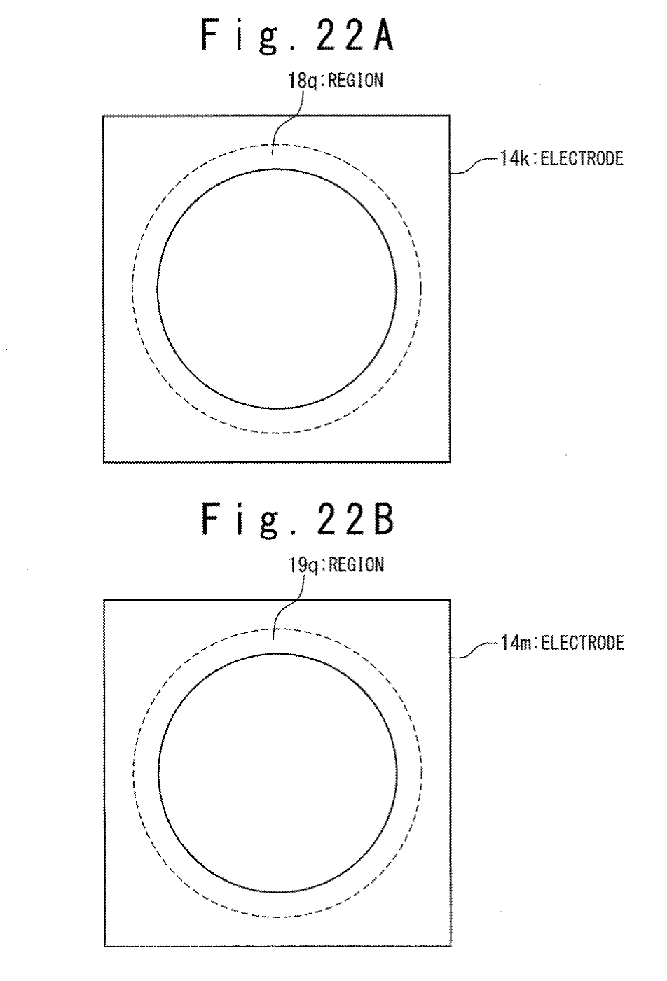

FIGS. 22A and 22B are a plane view of the electrode 14k in the second birefringence correction part and a plane view of the electrode 14m in the third birefringence correction part. As shown in FIG. 22A, the electrode 14k is a circle shown by a solid line in the drawing having the diameter equivalent to the numerical aperture 0.65 of the objective lens 6c, and is divided into an internal portion and an external portion. The internal portion of the circle includes a single region in the same manner of the electrode 14c in the second birefringence correction part included in the birefringence correction element 5a, and the external portion of the circle includes a single region 18q. In addition, as shown in FIG. 22B, the electrode 14m is a circle shown by a solid line in the drawing having the diameter equivalent to the numerical aperture 0.65 of the objective lens 6c, and is divided into an internal portion and an external portion. The internal portion of the circle includes a single region in the same manner of the electrode 14e in the third birefringence correction part included in the birefringence correction element 5a, and the external portion of the circle includes a single region 19q. Meanwhile, dashed lines in the drawings show circles having diameters equivalent to the numerical aperture 0.85 of the objective lens 6c.

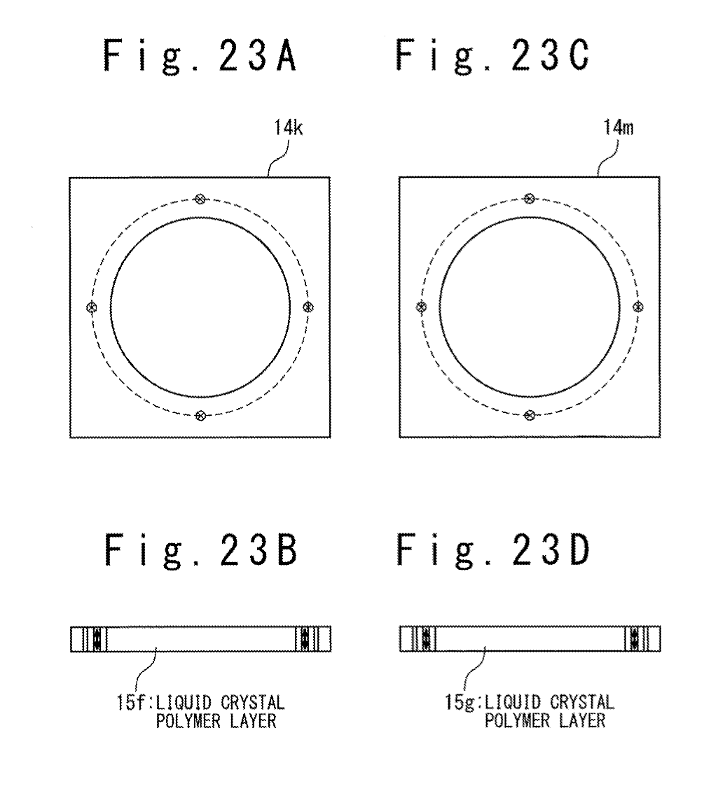

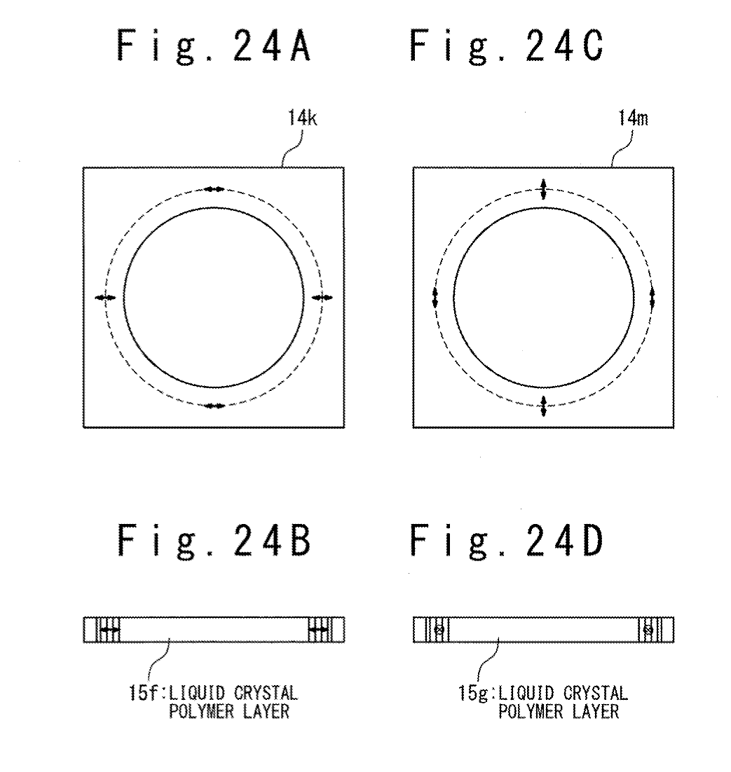

FIGS. 23A to 23D and FIGS. 24A to 24D are plane views of the electrode 14k in the second birefringence correction part and cross sectional views of the liquid crystal polymer layer 15f, and plane views of the electrode 14m in the third birefringence correction part and cross sectional views of the liquid crystal polymer layer 15g. Dashed lines in the drawings show circles having diameters equivalent to the numerical aperture 0.85 of the objective lens 6c. The arrowed lines in the drawings show the longitudinal direction of the liquid crystal polymer of the liquid crystal polymer layer 15f and the liquid crystal polymer layer 15g in the external portion of the circle having the diameter equivalent to the numerical aperture 0.65 of the objective lens 6c. Here, in the internal portion of the circle having the diameter equivalent to the numerical aperture 0.65 of the objective lens 6c, the configuration and the function of the second birefringence correction part and the third birefringence correction part included in the birefringence correction element 5c are the same as the configuration and the function of the second birefringence correction part and the third birefringence correction part included in the birefringence correction element 5a. Accordingly, in the birefringence correction element 5c, the second birefringence correction part and the third birefringence correction part can correct the influence of the in-plane birefringence of the protection layer of the disk 7, the vertical birefringence varying depending on the type of the disk 7, in the same manner as that of the birefringence correction element 5a.

An X axis is defined to a horizontal direction of the plane view of the electrode 14k and the plane view of the electrode 14m, a Y axis is defined to a vertical direction, and a Z axis is defined to the optical axis direction of the incident light. In the liquid crystal polymer layer 15f, the longitudinal direction of the liquid crystal polymer makes a predetermined angle with the Z axis in the X-Z plane in the same manner as that of the liquid crystal polymer layer 15b in the second birefringence correction part included in the birefringence correction element 5a. When this angle is θ2, the angle θ2 varies depending on the effective value of the alternating-current voltage applied between the electrode 14k and the electrode 14l. On this occasion, in a case where a predetermined phase difference generated between a polarization component of the X axis direction and a polarization component of the Y axis direction when a light transmits through the liquid crystal polymer layer 15f is φ2 and an effective value of the alternating-current voltage applied between the electrode 14k and the electrode 14l is Veff2, the liquid crystal polymer layer 15f is designed so that φ2 can be equal to 0° when Veff2 is equal to 3.5V and φ2 can be equal to −180° when Veff2 is equal to 1.5V in the same manner as that of the liquid crystal polymer layer 15b in the second birefringence correction part included in the birefringence correction element 5a. Meanwhile, in the liquid crystal polymer layer 15g, the longitudinal direction of the liquid crystal polymer makes a predetermined angle with the Z axis in the Y-Z plane in the same manner as that of the liquid crystal polymer layer 15c in the third birefringence correction part included in the birefringence correction element 5a. When this angle is θ3, the angle θ3 varies depending on the effective value of the alternating-current voltage applied between the electrode 14m and the electrode 14n. On this occasion, in a case where a predetermined phase difference generated between a polarization component of the X axis direction and a polarization component of the Y axis direction when a light transmits through the liquid crystal polymer layer 15g is φ3 and an effective value of the alternating-current voltage applied between the electrode 14m and the electrode 14n is Veff3, the liquid crystal polymer layer 15g is designed so that φ3 can be equal to 0° when Veff3 is equal to 3.5V and φ3 can be equal to 180° when Veff3 is equal to 1.5V in the same manner as that of the liquid crystal polymer layer 15c in the third birefringence correction part included in the birefringence correction element 5a.

As the disk 7, in the case of using an optical recording medium corresponding to the optical condition where the wavelength of the light source is 405 nm, the numerical aperture of the objective lens is 0.85, and the thickness of the protection layer of the optical recording medium is 0.1 mm, Veff2 is equal to 3.5V and Veff3 is equal to 3.5V. On this occasion, φ2 is equal to 0° and φ3 is equal to 0°. In addition, θ2 is equal to 0° and θ3 is equal to 0° as shown in FIGS. 23A to 23D. Accordingly, the incident light entirely transmits through both of the diffractive grating constituted by the liquid crystal polymer layer 15f and the filling material 16a and the diffractive grating constituted by the liquid crystal polymer layer 15g and the filling material 16b. As a result, the numerical aperture of the objective lens 6c is 0.85 that is determined by the effective diameter of the objective lens 6c itself.

As the disk 7, on the other hand, in the case of using an optical recording medium corresponding to the optical condition where the wavelength of the light source is 405 nm, the numerical aperture of the objective lens is 0.65, and the thickness of the protection layer of the optical recording medium is 0.6 mm, Veff2 is equal to 1.5V and Veff3 is equal to 1.5V. On this occasion, φ2 is equal to −180° and φ3 is equal to 180°. In addition, θ2 is not equal to 0° and θ3 is not equal to 0° as shown in FIGS. 24A to 24D. Accordingly, the polarization component of the X axis direction of the incident light is entirely diffracted by the diffractive grating constituted by the liquid crystal polymer layer 15f and the filling material 16a to be ineffective light, and the polarization component of the Y axis direction of the incident light is entirely diffracted by the diffractive grating constituted by the liquid crystal polymer layer 15g and the filling material 16b to be ineffective light. As a result, the numerical aperture of the objective lens 6c is 0.65 that is determined by an internal diameter of the region 18q in the electrode 14k and an internal diameter of the region 19q in the electrode 14m.

As explained above, both of the influence of the in-plane birefringence of and the influence of the vertical birefringence of the protection layer of the disk 7, which vary depending on the type of the disk 7, can be corrected by the birefringence correction element 5c in the same manner as that of the birefringence correction element 5a. Accordingly, in the present exemplary embodiment, decrease of the amount of light received by the optical detector 10 caused by the in-plane birefringence of the protection layer of the disk 7 and decrease of the amount of light received by the optical detector 10 caused by the vertical birefringence of the protection layer of the disk 7 do not occur in reproducing information from the disk 7, and accordingly a high signal-to-noise ratio can be obtained. Moreover, the birefringence correction element 5c controls the numerical aperture of the objective lens depending on the type of the disk 7. Accordingly, the present exemplary embodiment does not need the objective lens switching mechanism, and has an effect of being suitable for the down sizing, the weight reducing, and the cost saving since a new optical element for controlling the numerical aperture of the objective lens depending on the type of the disk 7 is not required.

An optical head device according to a fourth exemplary embodiment of the present invention is configured by replacing the birefringence correction element 5c of the third exemplary embodiment by a birefringence correction element 5d. The configuration is the same as that shown in FIG. 20.

The birefringence correction element 5d is configured by replacing the first birefringence correction part and the second birefringence correction part included in the birefringence correction element 5b in the second exemplary embodiment by another first birefringence correction part and another second birefringence correction part, respectively.

The cross sectional views of the first birefringence correction part and the second birefringence correction part included in the birefringence correction element 5d are almost the same as those shown in FIGS. 21A and 21B. However, the electrode 14k and the electrode 14m have a pattern also in the internal portion of the circle having the diameter equivalent to the numerical aperture 0.65 of the objective lens 6c.

The plane view of the electrode 14k in the first birefringence correction part and the plane view of the electrode 14m in the second birefringence correction part are almost the same as those shown in FIGS. 22A and 22B. However, the electrode 14k and the electrode 14m have a pattern also in the internal. portion of the circle having the diameter equivalent to the numerical aperture 0.65 of the objective lens 6c. In the same manner as that of. the electrode 14g in the first birefringence correction part included in the birefringence correction element 5b, the electrode 14k is divided into sixteen regions by three concentric circles including an optical axis as the center and two straight lines passing the optical axis that are perpendicular to each other in the internal portion of the circle having the diameter equivalent to the numerical aperture 0.65 of the objective lens 6c. Additionally, in the same manner as that of the electrode 14i in the second birefringence correction part included in the birefringence correction element 5b, the electrode 14m is divided into sixteen regions by three concentric circles including an optical axis as the center and two straight lines passing the optical axis that are perpendicular to each other in the internal portion of the circle having the diameter equivalent to the numerical aperture 0.65 of the objective lens 6c.

The plane view of the electrode 14k in the first birefringence correction part and the cross sectional view of the liquid crystal polymer layer 15f and the plane view of the electrode 14m in the second birefringence correction part and the cross sectional view of the liquid crystal polymer layer 15g are almost the same as those shown in FIGS. 23A to 23D and FIGS. 24A to 24D. However, the electrode 14k and the electrode 14m have a pattern also in the internal portion of the circle having the diameter equivalent to the numerical aperture 0.65 of the objective lens 6c. Here, in the internal portion of the circle having the diameter equivalent to the numerical aperture 0.65 of the objective lens 6c, the configurations and the functions of the first birefringence correction part and the second birefringence correction part included in the birefringence correction element 5d are the same as the configurations and the functions of the first birefringence correction part and the second birefringence correction part included in the birefringence correction element 5b. Accordingly, in the birefringence correction element 5d, the first birefringence correction part and the second birefringence correction part can correct both of the influence of the in-plane birefringence of and the influence of the vertical birefringence of the protection layer of the disk 7, the in-plane birefringence and the vertical birefringence varying depending on the type of the disk 7, in the same manner as that of the birefringence correction element 5b.

As explained above, both of the influence of the in-plane birefringence of and the influence of the vertical birefringence of the protection layer of the disk 7, which vary depending on the type of the disk 7, can be corrected by the birefringence correction element 5d in the same manner as that of the birefringence correction element 5b. Accordingly, in the present exemplary embodiment, decrease of the amount of light received by the optical detector 10 caused by the in-plane birefringence of the protection layer of the disk 7 and decrease of the amount of light received by the optical detector 10 caused by the vertical birefringence of the protection layer of the disk 7 do not occur in reproducing information from the disk 7, and accordingly a high signal-to-noise ratio can be obtained. Moreover, the birefringence correction element 5d controls the numerical aperture of the objective lens depending on the type of the disk 7. Accordingly, the present exemplary embodiment does not need the objective lens switching mechanism, and has an effect of being suitable for the down sizing, the weight reducing, and the cost saving since a new optical element for controlling the numerical aperture of the objective lens depending on the type of the disk 7 is not required.

The number of the birefringence correction parts included in the birefringence correction element is three in the birefringence correction element explained in the third exemplary embodiment, but the number is two in the birefringence correction element explained in the fourth exemplary embodiment. Accordingly, since having the birefringence correction element of a simple configuration compared to the optical head device according the third exemplary embodiment, the optical head device according to the fourth exemplary embodiment is suitable for the down sizing, the weight reducing, and the cost saving, and has an effect that a higher optical output can be obtained in the recording and a higher signal-to-noise ratio can be obtained in the reproducing since a loss of the light transmitting through the birefringence correction element is small.

Meanwhile, in an optical recording medium, a reproducing-only type optical recording medium and a recordable optical recording medium are there, an optical characteristic of a recording mark is different between them. In the reproducing-only type optical recording medium, the phase of reflected light is different in a mark portion and in a space portion, and in the write-once type optical recording medium, the intensity of reflected light is different in a mark portion and in a space portion. Thus, when the optical characteristic of a recording mark varies, the influence of the birefringence on the protection layer of the optical recording medium varies even in a case of employing a same optical condition for use.

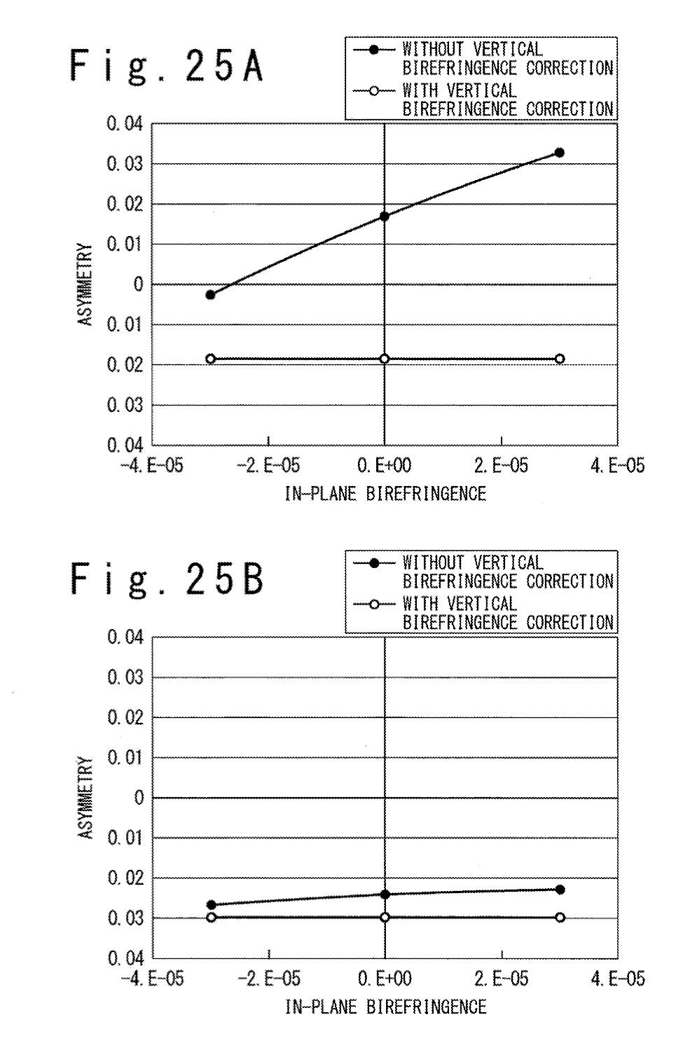

FIGS. 25A and 25B show calculation examples of a relationship between the in-plane birefringence of the protection layer of the optical recording medium and the asymmetry of a reproduction signal of the case where the wavelength of the light source is 405 nm, the numerical aperture of the objective lens is 0.65, and the thickness of the protection layer of the optical recording medium is 0.6 mm. Here, the asymmetry is an asymmetry to a shortest recording mark in a case where a modulation method of the recording signal is a 8/12 modulation and a bit length is 0.153 μm. FIG. 25A shows a calculation example for the reproducing-only type optical recording medium in which a depth of the mark portion to the space portion is 52.5 nm, and FIG. 25B shows a calculation example for the write-once type optical recording medium in which a reflection ratio of the mark portion to the space portion is 2.5. In addition, the vertical birefringence of the protection layer of the optical recording medium is 7×10⁻⁴, black dots and white dots in the drawings show a case of not correcting the influence of the vertical birefringence and a case of correcting the influence of the vertical birefringence, respectively.

In the recordable optical recording medium, the asymmetry scarcely depends on the in-plane birefringence and the vertical birefringence. On the other hand, in the reproducing-only type optical recording medium, the asymmetry considerably depends on the in-plane birefringence and the vertical birefringence. For this reason, when the recording mark is formed so that the asymmetry of the case of not correcting the influence of the in-plane birefringence and the influence of the vertical birefringence can be an optimum value, the asymmetry of the case of correcting the influence of the in-plane birefringence and the influence of the vertical birefringence cannot be the optimum value. As a result, when the influence of the in-plane birefringence and the influence of the vertical birefringence are corrected, the signal-to noise ratio may deteriorate even though the amount of light received by the optical detector does not decrease. In such a case, the influence of the in-plane birefringence and the influence of the vertical birefringence are better not to be corrected. That is, it is better to determine whether or not to correct the influence of the in-plane birefringence and the influence of the vertical birefringence of the protection layer of the optical recording medium in consideration of not only an optical condition for use but also the optical characteristic of the recording mark.

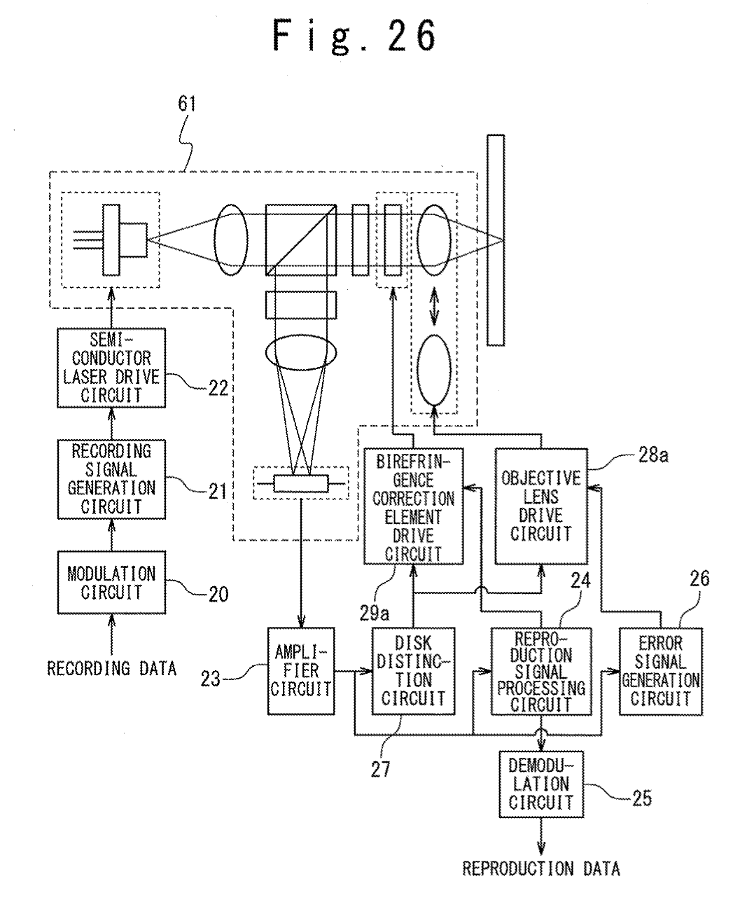

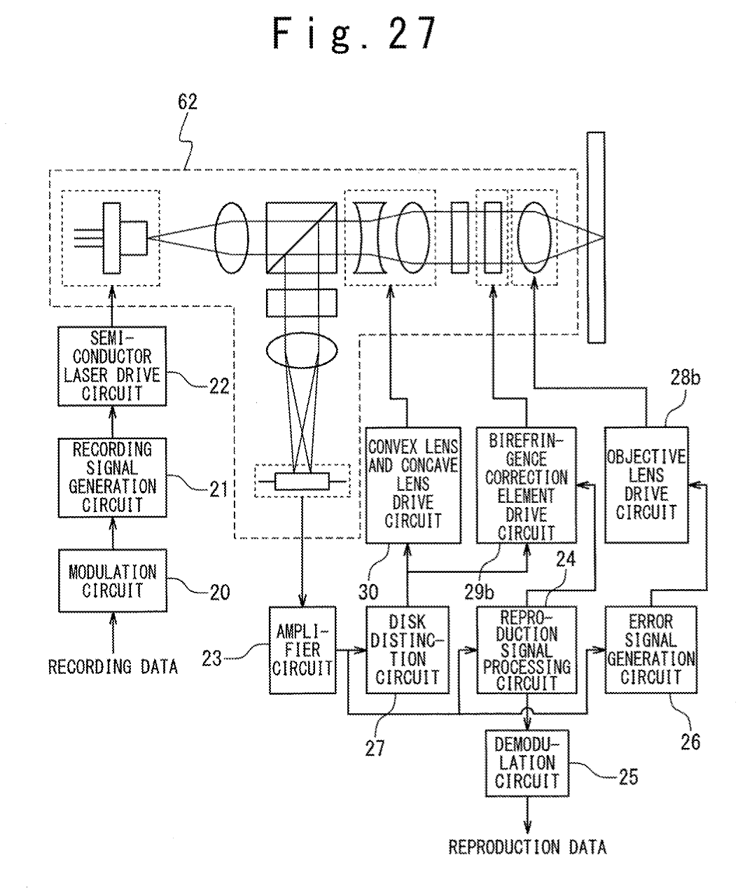

FIG. 26 shows a configuration of an optical information recording/reproducing device according to the fifth exemplary embodiment. The optical information recording/reproducing device includes the optical head device 61 shown in FIG. 9, a modulation circuit 20, a recording signal generation circuit 21, a semiconductor laser drive circuit 22, an amplifier circuit 23, a reproduction signal processing circuit 24, a demodulation circuit 25, an error signal generation circuit 26, a disk distinction circuit 27, an objective lens drive circuit 28a, and a birefringence correction element drive circuit 29a. All circuits including the circuits from the modulation circuit 20 to the birefringence correction element drive circuit 29a are controlled by a controller that is not shown in the drawing.

The modulation circuit 20 modulates recording data to be recorded on the disk 7 in accordance with a modulation rule. The recording signal generation circuit 21 generates a recording signal for driving the semiconductor laser 1 in accordance with a recording strategy on the basis of a signal modulated by the modulation circuit 20. The semiconductor laser drive circuit 22 supplies an electric current based on the recording signal to the semiconductor laser 1 to drive the semiconductor laser 1 on the basis of the recording signal generated by the recording signal generation circuit 21. In this manner, data is recorded on the disk 7.

The amplifier circuit 23 amplifies an output from each light receiving part of the optical detector 10. The reproduction signal processing circuit 24 carries out the generation, the waveform equalization, and the digitization of a reproduced signal that is a mark/space signal recorded on the disk 7 on the basis of the signal amplified by the amplifier circuit 23. The demodulation circuit 25 demodulates the signal digitized by the reproduction signal processing circuit 24 in accordance with the demodulation rule. In this manner, the reproduction data is reproduced from the disk 7.

The error signal generation circuit 26 generates the focus error signal and the track error signal on the basis of the signal amplified by the amplifier circuit 23. The disk distinction circuit 27 distinguishes whether the disk 7 is an optical recording medium corresponding to an optical condition where the wavelength of the light source is 405 nm, the numerical aperture of the objective lens is 0.85, and the thickness of the protection layer of the optical recording medium is 0.1 mm or an optical recording medium corresponding to an optical condition where the wavelength of the light source is 405 nm, the numerical aperture of the objective lens is 0.65, and the thickness of the protection layer of the optical recording medium is 0.6 mm on the basis of the signal amplified by the amplifier circuit 23.

The objective lens drive circuit 28a drives the objective lens switching mechanism (not shown in the drawing) for switching an objective lens to be used between the objective lens 6a and the objective lens 6b depending on the type of the disk 7 distinguished by the disk distinction circuit 27, and arranges any one of the objective lens 6a and the objective lens 6b in the light path. Moreover, on the basis of the error signal generated in the error signal generation circuit 26, the circuit supplies an electric current based on the error signal to an actuator (not shown in the drawing) for driving the objective lens 6a or the objective lens 6b and drives the objective lens 6a or the objective lens 6b. In this manner, the servo of the focus and track is carried out.

Other than this, the optical information recording/reproducing device includes a positioner control circuit and a spindle control circuit. The positioner control circuit moves whole of the optical head device 61 to the radius direction of the disk 7 by using a motor (not shown in the drawing). The spindle control circuit rotates the disk 7 by using a motor. In this manner, the servo of the positioner and spindle is carried out.

On the basis of the type of the disk 7 distinguished by the disk distinction circuit 27 and the signal digitized by the reproduction signal processing circuit 24, the birefringence correction element drive circuit 29a supplies an alternating-current voltage to the electrode of the birefringence correction element 5a to drive the birefringence correction element 5a so that the influence of the in-plane birefringence of and the influence of the vertical birefringence of the protection layer of the disk 7 can be corrected. The correction of the influence of the vertical birefringence of the protection layer of the disk 7 is carried out by varying the effective value of the alternating-current voltage supplied to the birefringence correction element 5a depending on the type of the disk 7. The correction of the influence of the in-plane birefringence of the protection layer of the disk 7 is carried out not only depending on the type of the disk 7 but also varying the effective value of the alternating-current voltage supplied to the birefringence correction element 5a so that an error rate of the digitized signal can be minimized. This is because that while the vertical birefringence is approximately-uniquely determined depending on the material of the protection layer, the in-plane birefringence depends on a condition for manufacture of the protection layer.

The optical head device 61 of this optical information recording/reproducing device can operate in the same manner as an optical head device configured by replacing the birefringence correction element 5a by the birefringence correction element 5b explained in the second exemplary embodiment.

FIG. 27 shows a configuration of an optical information recording/reproducing device according to a sixth exemplary embodiment. The optical information recording/reproducing device includes the optical head device 62 shown in FIG. 20, the modulation circuit 20, the recording signal generation circuit 21, the semiconductor laser drive circuit 22, the amplifier circuit 23, the reproduction signal processing circuit 24, the demodulation circuit 25, the error signal generation circuit 26, the disk distinction circuit 27, an objective lens drive circuit 28b, a birefringence correction element drive circuit 29b, and a concave and convex lenses drive circuit 30. All circuits including the circuits from the modulation circuit 20 to the concave and convex lenses drive circuit 30 are controlled by a controller that is not shown in the drawing.

The operations of circuit regarding the data recording from the modulation circuit 20 to the semiconductor laser drive circuit 22, circuits regarding the data reproducing from the amplifier circuit 23 to the demodulation circuit 25, the error signal generation circuit 26, and the disk distinction circuit 27 are the same as those explained in the fifth exemplary embodiment.

On the basis of the error signal generated in the error signal generation circuit 26, the objective lens drive circuit 28b supplies an electric current based on the error signal to an actuator (not shown in the drawing) for driving the objective lens 6c and drives the objective lens 6c. In this manner, the servo of the focus and track is carried out.

On the basis of the type of the disk 7 distinguished by the disk distinction circuit 27 and the signal digitized by the reproduction signal processing circuit 24, the birefringence correction element drive circuit 29b supplies an alternating-current voltage to the electrode of the birefringence correction element 5c to drive the birefringence correction element 5c so that the influence of the in-plane birefringence of and the influence of the vertical birefringence of the protection layer of the disk 7 can be corrected. In addition, on the basis of the type of the disk 7 distinguished by the disk distinction circuit 27, the circuit supplies an alternating-current voltage to the electrode of the birefringence correction element 5c to drive the birefringence correction element 5c, and controls the numerical aperture of the objective lens 6c depending on the type of the disk 7.

On the basis of the type of the disk 7 distinguished by the disk distinction circuit 27, the concave and convex lenses drive circuit 30 drives the concave and convex lenses drive mechanism (not shown in the drawing) for moving one of the concave lens 11 and the convex lens 12 to the optical axis direction to correct the spherical aberration depending on the type of the disk 7.

The optical head device 62 of this optical information recording/reproducing device can operate in the same manner as an optical head device configured by replacing the birefringence correction element 5c by the birefringence correction element 5d explained in the fourth exemplary embodiment.

The optical information recording/reproducing devices according to the fifth and the sixth exemplary embodiments are recording/reproducing devices for carrying out recording and reproducing to the disk 7. As the exemplary embodiments of the optical information recording/reproducing device of the present invention, a reproducing-only device for only carrying out the reproducing to the disk 7 may be employed. In this case, the semiconductor laser 1 is not driven on the basis of the recording signal but driven so that a light amount of the emission light can be a constant value by the semiconductor laser drive circuit 22.

As described above, as effects of optical head devices and optical information recording/reproducing devices according to the present invention, a high signal-to-noise ratio can be obtained, since it is prevented in a simple configuration that the amount of light received by the optical detector caused by the in-plane birefringence of the protection layer of the optical recording medium is decreased and the amount of light received by the optical detector caused by the vertical birefringence of the protection layer of the optical recording medium is decreased. This is because that single birefringence correction means corrects both of the influence of the in-plane birefringence and the influence of the vertical birefringence of the protection layer of the optical recording medium, the in-plane birefringence and vertical birefringence varying depending on the type of the optical recording medium. As described above, the present invention has been explained referring to some exemplary embodiments thereof. But the present invention is not limited to the above-mentioned exemplary embodiments. Various modifications that can be understood by a person skilled in the art can be applied to the configurations and details of the present invention within the scope of the present invention.

What is claimed is:

1. An optical head device comprising:
a light focus part configured to focus emission light emitted from a light source on an optical recording medium being one of plural types of optical recording media which are different from each other in an optical condition for use or an optical characteristic of a recording mark;
an optical detection part configured to receive reflection light reflected by the optical recording medium;
a light separation part configured to separate the emission light and the reflection light, and
a single birefringence correction part arranged between the light separation part and the light focus part and configured to correct an influence of an in-plane birefringence of a protection layer and an influence of a vertical birefringence of the optical recording medium which are different depending on the type of the optical recording medium.

2. The optical head device according to claim 1, wherein the birefringence correction part comprises a plurality of birefringence correction parts, and
each of the plurality of birefringence correction parts comprises:
a liquid crystal polymer layer;
a first electrode and a second electrode which sandwich the liquid crystal polymer layer and apply an alternating current to the liquid crystal polymer layer.

3. The optical head device according to claim 2, wherein the plurality of birefringence correction parts comprises:
a first birefringence correction part configured to correct an influence of a vertical birefringence of the protection layer of the optical recording medium; and
a second birefringence correction part and a third birefringence correction part which are configured to correct an influence of an in-plane birefringence of the protection layer of the optical recording medium.

4. The optical head device according to claim 3, wherein the first electrode included in the first birefringence correction part has a plurality of regions which are divided corresponding to a distance from an optical axis of an incident light.

5. The optical head device according to claim 3, wherein the liquid crystal polymer layer included in each of the second birefringence correction part and the third birefringence correction part has a region which forms a diffraction grating formed by a liquid crystal polymer and a filler in a region where a distance from an optical axis of an incident light is equal to or more than a predetermined value to function to change an effective numerical aperture of the light focus part in response to a type of the optical recording medium.

6. The optical head device according to claim 2, wherein the plurality of birefringence correction part comprises a first birefringence correction part configured to correct an influence of an in-plane birefringence and a vertical birefringence of the protection layer of the optical recording medium and a second birefringence correction part configured to correct an influence of an in-plane birefringence and a vertical birefringence of the protection layer of the optical recording medium.

7. The optical head device according to claim 6, wherein each of the first electrode included in the first birefringence correction part and the first electrode included in the second birefringence correction part has a plurality of regions which are divided in accordance with a distance from an optical axis of an incident light and an angle around the optical axis.

8. The optical head device according to claim 6, wherein each of the liquid crystal polymer layer included in the first birefringence correction part and the liquid crystal polymer layer included in the second birefringence correction part has a region which forms a diffraction grating formed by a liquid crystal polymer and a filler in a region where a distance from an optical axis of an incident light is equal to or more than a predetermined value to function to change an effective numerical aperture of the light focus part in response to a type of the optical recording medium.

9. An optical information recording/reproducing device comprising:
an optical head device according to claim 1; and
a drive circuit configured to drive the birefringence correction part to correct an influence of an in-plane birefringence of the protection layer of the optical recording medium and an influence of a vertical birefringence of the protection layer which are different depending on a type of the optical recording medium.

10. An optical information recording/reproducing method comprising:
focusing emission light emitted by a light source on an optical recording medium being one of plural types of optical recording media which are different from each other in an optical condition for use or an optical characteristic of a recording mark;
receiving a reflection light reflected by the optical recording medium;
separating the emission light and the reflected light; and
correcting an influence of an in-plane birefringence of a protection layer of the optical recording medium and an influence of a vertical birefringence of the protection layer which are different depending on the type of the to optical recording medium by a single birefringence correction part.
